(19) United States
(12) Patent Application Publication
(10) Pub. No.: US 2013/0342704 A1
(43) Pub. Date: Dec. 26, 2013

(54) INTERACTIVE AUDIOVISUAL DEVICE

(71) Applicant: VillageTech Solutions, Menlo Park, CA (US)

(72) Inventors: Peter Richard Williams, Litchfield, CT (US); Roja Nunna, Chennai (IN); Rachelle Morris, West Vancouver (CA); Alyssa Belisle, Lisbon, CT (US); Kielan Crockett Crow, Portola Valley, CA (US)

(21) Appl. No.: 13/925,336

(22) Filed: Jun. 24, 2013

Related U.S. Application Data
(60) Provisional application No. 61/663,558, filed on Jun. 23, 2012.

(51) Int. Cl. G09B 5/06

(52) U.S. Cl. CPC G09B 5/067
USPC 348/164; 348/838; 29/592.1

(57) ABSTRACT

Disclosed is a portable low-power audio-visual (A/V) device including: a housing enclosing a computer board, a projector, a speaker, a power supply and optionally a webcam. The power supply may be one or more power converters connected to a DC battery. The A/V device may include a user interface enabling web browsing with functions including scroll, refresh, home, listing playable/viewable files, and generating a projection screen keyboard. Navigating on the screen can be achieved by a user input system that is calibrated to be used on a projected image, such as an infrared point source.

### CROSS-REFERENCE TO RELATED APPLICATION

This application claims the benefit of U.S. Provisional Patent Application Ser. No. 61/663,558 filed Jun. 23, 2012, and the subject matter thereof is incorporated herein by reference in its entirety.

### FIELD OF INVENTION

This invention relates generally to an interactive audiovisual display system, and in particular to providing an interactive audio-visual system for low-cost education.

### BACKGROUND

Most students and teachers in developing countries lack the media used by many developed world counterparts to enhance education, such as projectors, the Web, etc. These countries lack stable infrastructures for education, such as electricity and textbooks. Isolated teachers lack training, resources, and support in these situations. Monitoring of both student and teacher performance is difficult. This learning-inertia holds back efforts to overcome poverty. The limited infrastructure, lack of sophistication of device users, and lack of free availability of plug-in electronics prevent the design and manufacturing of a device that can effectively bring the educational resources to isolated portions of developing countries.

### DISCLOSURE OF INVENTION

Disclosed herein is an audio-visual device suitable for use in a classroom or other learning environment. The audio-visual device includes a computing apparatus optionally having an user interface for connection to the Internet, the computer interconnected to i) a low-power projector for delivering a clear image, ii) an audio function for delivering sound, iii) an interactive whiteboard feature for collecting input, and optionally iv) a video recorder adaptable for live video conferencing or video recording. The projector preferably runs on a battery and more preferably on a 12V battery. The specification of the projector maybe minimized to provide an image with reasonable resolution and light intensity that is clearly viewable in a classroom of students. The user interface preferably comprises minimal hardware that is low-cost and easy to replace. The video recorder may be capable of sharing videos among multiple users in addition to live video conferencing over the Internet. A preferable embodiment of the audio-visual device includes a suitable chassis or other container for the device. In some embodiments, the device is suitable for use in any learning or teaching environment. In the preferred embodiment, the device is designed as a low-cost and easy to use device with low maintenance that is suitable for use in locations where a stable power source is not readily accessible and where the costs of production, use, and maintenance are highly limited.

The audio/visual (A/V) device disclosed herein is discovered to be advantageous for the developing world because this A/V device is an affordable, interactive, low power-consuming audio-visual technology to support teachers and promote achievement. The A/V device is developed to answer for such problems described above, aiming to inspire and educate students and teachers by creating a two-way window—a new way to connect students and teachers to Web content and to their peers throughout the world.

Specifically, the examples and embodiments of the A/V device disclosed herein overcome at least four obstacles: a) isolation, lack of internet—it incorporates pre-loaded textbooks and rich internet content so that students and teachers can have access to educational material even when an internet connection is not available; b) lack of a stable power grid—the A/V device uses only 100 W, so solar is practical; c) cost—one $300-500 device can serve 200 students daily; and d) passivity—students and teachers can search pre-loaded textbooks and content and record themselves and upload files to enable interaction with peers.

The A/V device may be a single unit. A room serving as ‘theater’ can take rotations of students. The A/V device may run on deep-cycle 12 V batteries, may access the Web, and may have an easy-to-use interface. The A/V device may include portable or removable storage, robust audio, body motion or gesture monitor, webcam, microphone, or any combination thereof. The A/V device may project at least a 3 ft×4 ft image (video or smart board) onto a wall.

The A/V device may be a multimedia tool serving as an open invitation for high-value content that can assist both students and teachers. The A/V device may enable teachers to get training and find ways to collaborate through the A/V device; adults to see a world of knowledge; school managers to have a means to monitor performance; and content providers and publishers to gain a huge audience. Thus, the A/V device can benefit the world as its population becomes better informed, enabled and motivated. Students can gain skills that may lead to higher education and greater civic engagement.

Below are descriptions of these various components and steps of assembling and operating the components of the A/V device. Described includes novel solutions to problems that typically prevent these components from being integrated into a single system. Some embodiments of the invention have other aspects, elements, features, and steps in addition to or in place of what is described above. These potential additions and replacements are described throughout the rest of the specification

### BRIEF DESCRIPTION OF THE DRAWINGS

FIG. 1 illustrates an audio visual (A/V) device implementing a user interface on a projected image via an infrared (IR) camera and an IR light source.

FIG. 2 is a perspective view of an embodiment of the A/V device.

FIG. 3 illustrates an example of a block diagram of a computer board of the A/V device.

FIG. 4 is a block diagram of a further embodiment of the A/V device.

FIG. 5A is a top view of a right hand section of an IR emitter used in conjunction with the A/V device.

FIG. 5B is a cross-section view of the IR emitter.

FIG. 5C is a right hand section of an end view of the IR emitter.

FIG. 5D is a top view of an example battery compartment cover of the IR emitter.

FIG. 5E is a side view of an example battery compartment cover of the IR emitter.

FIG. 5F is an end view of an example battery compartment cover of the IR emitter.

FIG. 5G is a circuit diagram view of the IR emitter.

FIG. 6 is a perspective view of an IR light source mounted in a finger cap device.

FIG. 7 is a schematic of the timer with LED.

FIG. 8 is an oscilloscope graph of the output from the timer as configured in FIG. 7.

FIG. 9 is a flow chart of a method of operating the IR camera and the IR light source.

FIGS. 10A-10F illustrate various views of example configurations of the components of the A/V device, including (A) a top perspective view, (B) a top view, (C) a side view, (D) a bottom perspective view, (E) a partial side view, and (F) a top plan view.

FIG. 11 is a schematic example of a flyback regulator for the power supply for the single board computer.

FIG. 12 is an efficiency curve graph for the schematic in FIG. 11 at 10.5 V (orange), 11.25 V (green) and 12 V (blue).

FIG. 13 is a schematic for an n-channel boost converter for the power supply for the projector.

FIG. 14 is the efficiency curve graph for the schematic in FIG. 13 at 10.5V, 11.25 V and 12 V.

FIG. 15A is an example of a step up converter of a power supply.

FIG. 15B is an example of a step down converter of a power supply.

FIG. 15C are examples of external connectors of a power supply.

FIG. 15D is an example of a protection circuit of a power supply.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

Disclosed herein is an audio visual (A/V) device for providing an interactive classroom experience at a rural area. The A/V device is a portable and low-power system with connectivity and class-room interaction and presentation capabilities. In example embodiment of the A/V device, the A/V device includes any combination of the following components:
a power supply that can adjust variable incoming DC voltage to suit component power supplies of a projector and/or a computer/computing board,
the low-power projector system that projects an image with reasonable resolution and light intensity clearly viewable by a classroom of 30 or more students,
an accompanying audio component that can deliver clear sound to a classroom of ˜35 students connected to the projector,
the computer to control the A/V device, such as controlling the projector, the IR camera, the user interface, or any combination thereof,
an integrated solid-state storage for large quantities of educational material and pre-loaded content from the World Wide Web, which may be accessible through the user interface,
an internet connection to optionally connect the A/V device with the World Wide Web through a simple user interface,
the user interface comprised of minimal hardware which is low-cost and easy to replace,
an interactive whiteboard feature interconnected to the projector for receiving input,
optionally a video and audio recording device interconnected to the computer to record and share videos among users and/or to provide live video conferencing, and
a chassis to hold all the components.

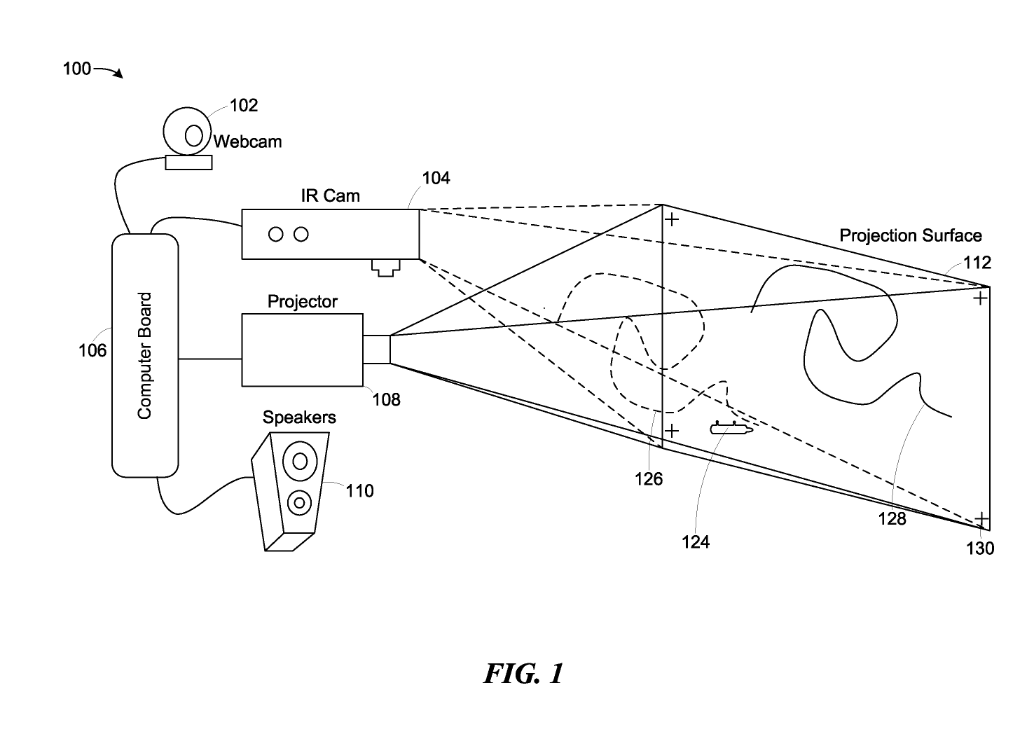

FIG. 1 illustrates an audio visual (A/V) device 100 implementing a user interface on a projection screen via an infrared (IR) camera and an IR light source. The A/V device 100 includes an IR camera 104, a computer board 106, a projector 108, one or more speakers 110, and optionally a webcam 102. Optionally, the A/V device 100 can also include a microphone (not shown). In some embodiments, the above components are attached to a chassis of the A/V device 100. The A/V device 100 may also include a removable IR light source 124.

For example, FIG. 1 illustrates how the movement of the IR light source 124 can be picked up by the IR camera 104 and drawn on a projected surface 112. The A/V device 100 may include the portable/detachable IR light source 124 to act as an input hardware for the A/V device 100. For example, the IR camera 104 and the IR light source 124 can work to transform the movement 126 of infrared (IR) light into cursor movement 128 on a projection surface 112. Optionally, calibration points 130 may be used to define the degree of freedom of the IR light source 124 by narrowing the borders of movement from the field of view of the IR camera 104. The calibration points 130 may be a process in which a homography model is used to calibrate the IR light source 124 given any angle of the projector 108. For example, four calibration points 130 marked with a ‘+’ sign can be used to define the coordinates of the projection surface 112 as seen by the IR camera 104.

The IR source 124 may be a rechargeable device. A charging station may be embedded within the A/V device 100. Alternatively, the charging station may be a separate device that can receive power input from a 12V battery to charge the battery or batteries inside the IR source 124. In some embodiments, batteries of the IR source 124 may be charged without opening the battery compartment, such as via exposed contacts or through induction charging. It is understood that although use of at least a battery as a power source for the IR source 124 is a preferred embodiment, other power sources may be used, such as piezoelectric or solar-based power sources. The IR source 124 may include a printed circuit board (PCB) with circuitry to implement the mouse click method.

In some embodiments, the IR camera 104 may track a point on the projection surface 112 reflecting the light from the IR source 124 instead of directly tracking the IR source 124. For example, instead of tracking an IR source with a diffuser that can send light rays directly towards the IR camera 104, the IR camera 104 may track a point on the projection surface 112 reflecting light from an IR source that is an off-the-shelf “laser” pointer. The laser dot on the projection surface 112 reflects the laser beam from the “laser” pointer. The resulting dot can then be captured and tracked by the IR camera 104.

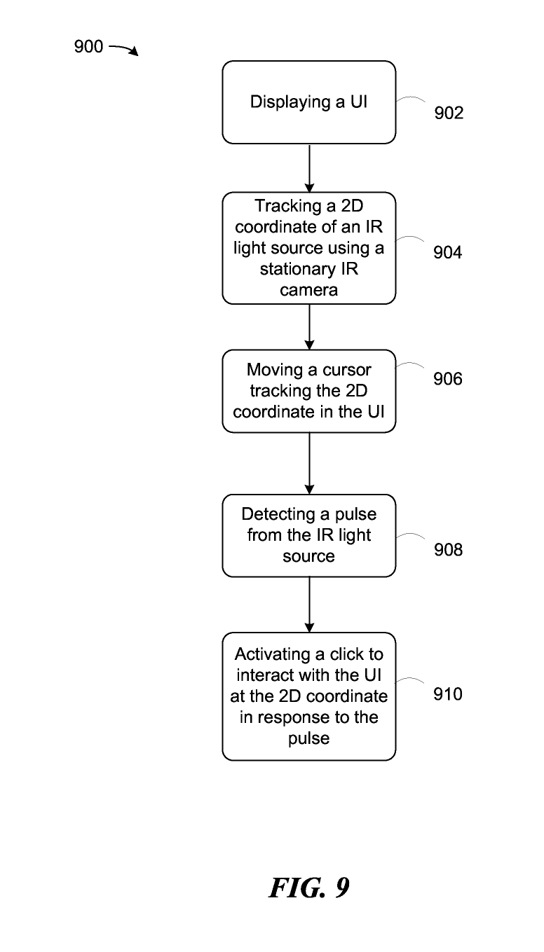

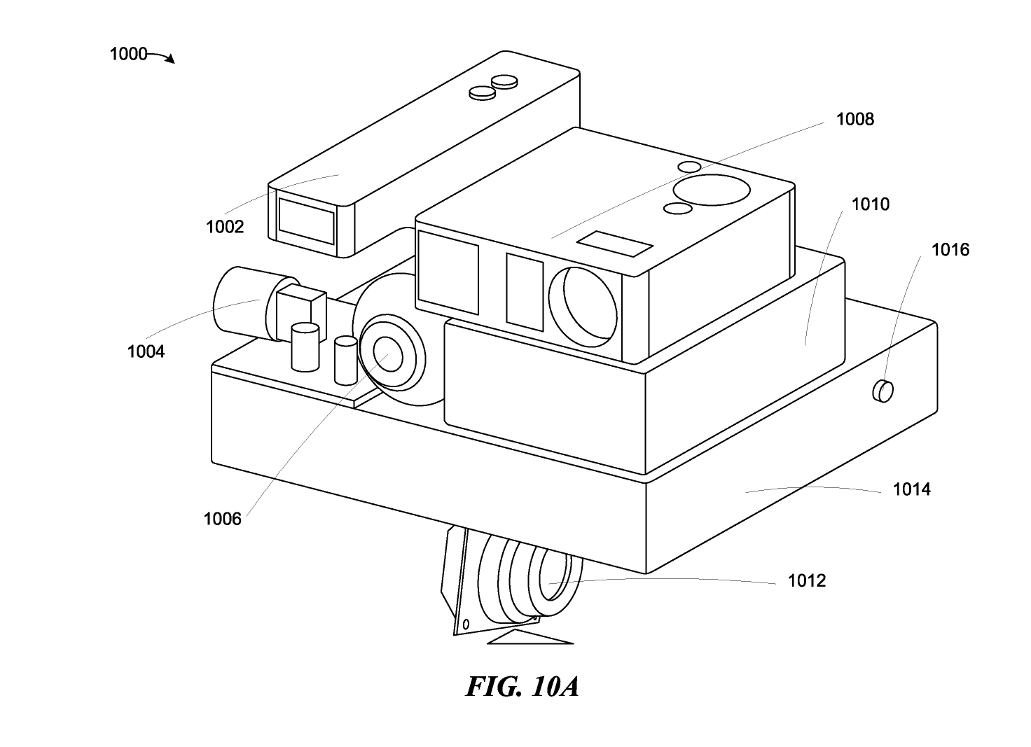

FIG. 9 is a flow chart of a method 900 of operating the IR camera 104 and the IR light source 124. The method 900 may be implemented through the computer board 106 and the circuitry in the IR source 124. The method 900 includes displaying a user interface through the projector 108, in a step 902; tracking the 2D coordinates of the IR light source 124 using the stationary IR camera 104, in a step 904; moving a cursor tracking the 2D coordinate on the user interface, in a step 906; detecting a pulse from the IR light source 124, in a step 908; and activating a mouse click to interact with the user interface at the 2D coordinate in response to detecting the pulse, in a step 910. In one embodiment, tracking the 2D coordinate in the step 904 may be done by a circuit within the IR camera 104. In other embodiments, the step 904 may be performed in the computer board 106 or an external circuitry within the A/V device 100.

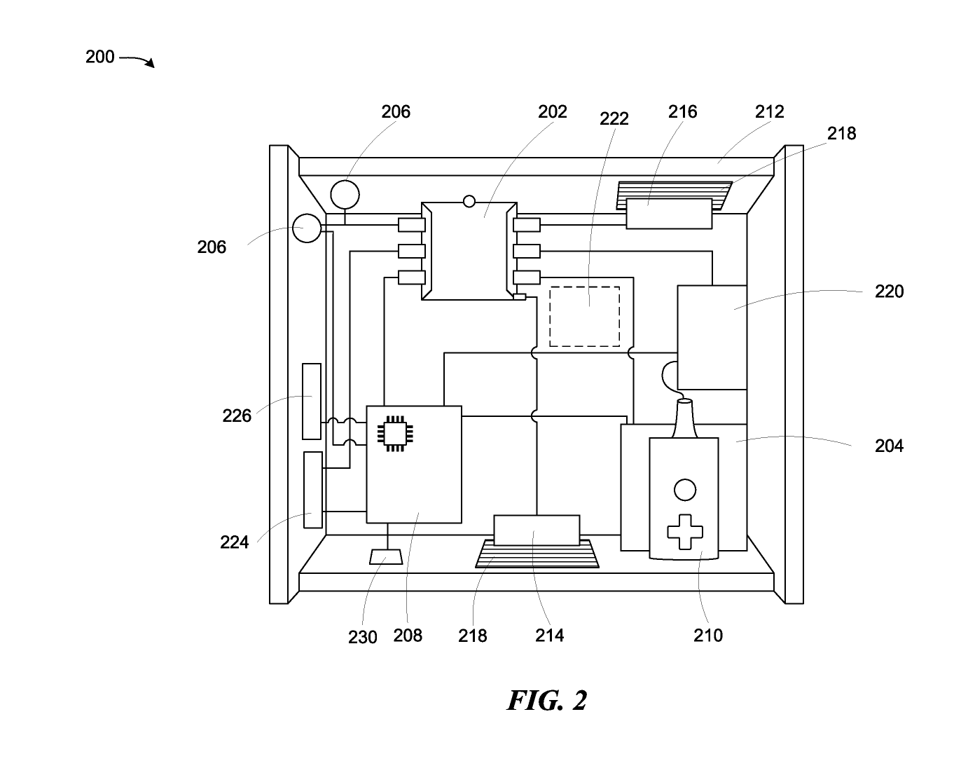

FIG. 2 is a perspective view of an embodiment of the A/V device 200, such as the A/V device 100 of FIG. 1. The A/V device 200 includes a power supply 202, a projector 204, one or more audio speakers 206, a computing board 208, an infrared camera 210, a chassis 212, or any combination thereof. The chassis 212 may include a cover (not shown) to close and protect the top of the A/V devices. The chassis 212 may include legs to grip onto a table top to prevent movement and to prop the A/V device 200 above the table top for ventilation. The chassis 212 may include one or more handle for ease of carrying the A/V device. The chassis 212 may also be mounted overhead in a classroom. Hence, the chassis 212 may include hardware mechanisms, such as mounting frame, hooks, screw holes, or attachment protrusion, adapted to attach onto an overhead structure, such as ceiling, overhead beam, trusses, a vertical wall, or any combination thereof.

Optionally the A/V device 200 may include an inflow fan 214 and an outflow fan 216. The inflow fan 214 and the outflow fan 216 may each be adjacent to a vent 218 in the chassis 212. Optionally, the A/V device 200 may also include a field programmable gate array (FPGA) 220. The FPGA 220, for example, can convert the signal received from the IR camera 210 for processing by the computing board 208, such as converting an i2C signal from the IR camera into a computer mouse serial signal for the computing board 208. In other embodiments, the IR camera 210 can communicate directly with the computing board 208 without the FPGA 220 by direct cabling or by mounting the IR camera 210 on the computing board 208.

The power supply 202 is an assembly of one or more power converters including at least one DC-to-DC converter. In one embodiment, the power supply 202 may include an energy source, such as a battery. In other embodiments, the power supply 202 provides a connection to the energy source external to the A/V device 200. The power supply 202, for example, can have a connection port for a portable 12V battery or other 12V inputs. The power supply 202 includes converters. The converters can convert the 12V into the voltages necessary to run the other components of the A/V device 200. In some embodiments, the power supply 202 includes a connection to a renewable energy source. For example, the renewable energy source may be connected to a solar panel or a wind mill.

Optionally, the A/V device 200 may also include an infrared source storage compartment 222. The infrared source storage compartment 222 may include a charging station to charge a rechargeable battery of an IR source, such as the IR light source 124 of FIG. 1. The charging station, for example, can be an induction charging station.

Also optionally, the A/V device 200 may include other peripheral connections, such as one or more USB ports 224, one or more external memory ports 226, or an external computing device connection port (not shown). While the external memory ports 226 are shown to be exposed from the chassis 212, it is understood that the external memory ports 226 may alternatively be attached and coupled to the computing board 208 and accessible by removing a top cover of the chassis 212.

The computing board 208 of the A/V device 200 may include an Ethernet connection. The computing board 208 may also include a Bluetooth or a WiFi adapter. The Ethernet connection may be extended to external Ethernet port 230 exposed from the chassis 212 as shown.

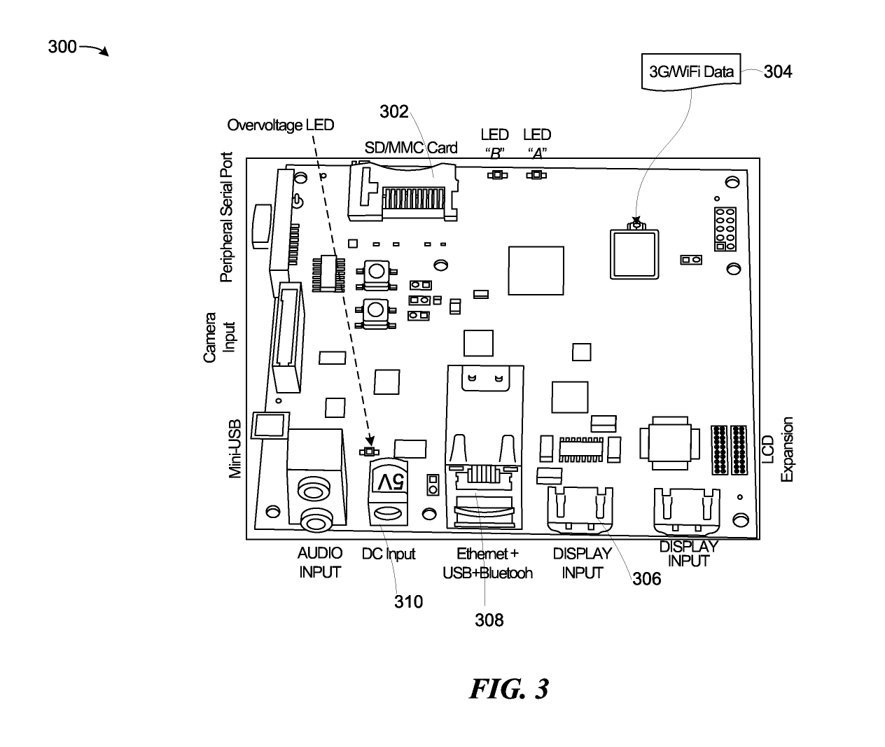

FIG. 3 illustrates an example of a block diagram of a computer board 300 of the A/V device. The computer board 300 includes an internal storage 302, such as one or more SD/MMC cards. The computer board 300 can include a network component 704, such as one or more a 3G adaptor, a WiFi adaptor, Ethernet connection, satellite radio, or any combination thereof. The computer board 300 can include a projector connection 306, such as HDMI or DVI ports. The computer board 300 can include an external component connection 308, such as a USB connection, a Bluetooth connection, or both. The computer board 300 can include multiple power inputs 310, such as a USB power input or a DC power input. The computer board 300 can further include many other components and connections for components as described herein.

### Projector

The A/V device disclosed herein includes a projector. Lumen output for a classroom is preferably between 200 and 300 ANSI lumens. The A/V device may be powered entirely by battery. In some embodiments, after adding up the power consumption of all other components of the A/V device, 50 W is preferably allotted for the projector. The projector, hence, may produce 200-300 lumens and consume less than 50 W.

One example of the projector is a FAVI mini projector. The FAVI mini projector has an output of 70 lumens. The FAVI projector is acceptable as the projector of the A/V device in a dark room. Alternatively, a Dell M110™ projector may be used.

For both examples, the brightness and contrast ratio settings range from 0 to 100. In a darkened room based on experimentation, the maximum lumen output of the FAVI projector is 51 lumens and the Dell projector is 250 lumens. Some difference in the experimental lumen outputs can be attributed to experimental and hardware inconsistencies.

In a preferred embodiment, the A/V device includes the Dell M110 as its projector. Since one embodiment of the invention may be for use in rural schools in developing nations, the A/V device is designed for an environment in developing nations and specifically in schools.

The A/V device may include a height raising stand to lift the A/V device to an optimal height in any classroom. In one embodiment, the height raising stand may be adjustable to different heights. The A/V device may also optionally have fixed height legs to space the A/V device higher from a table top for an air vent at the bottom surface to circulate air. The A/V device is portable and easily transported, and thus its overall weight is designed to be sufficiently low to allow an adult teacher to carry by him/herself, such as within 30 lbs. and preferably below 10 lbs. The A/V device through the projector and other components enables a teacher or a student to draw, save, and send the drawings and lesson plans, as well as providing an offline database of textbooks, videos, multimedia content, games, interactivity activities, and lesson plans.

### Audio

In one embodiment, pairs of speakers are implemented in the A/V device to achieve audio of reasonable sound quality. For example, the speaker can be Logitech LS211 speakers. In this embodiment, each pair of speakers may have a top peak power of 6 W. Hence, the audio system contributes at a maximum 12 W to the overall power consumption of the A/V device.

Optionally, the A/V device may include just the speaker cones and sound cards from the pairs of speakers to avoid bulkiness of the plastic casings. The speakers may be located on the sides and the back of the A/V device with an upward tilt of substantially 7°. In some embodiments, the angle for the tilt may be based on a visual estimate of 7°. The tilt angle is selected based on optimal sound wave dispersion to be used atop a table or mounted on a classroom structure, such as an overhead structure or a column structure. A more acoustically savvy approach for speaker placement may be implemented. For example, a sound engineering software program that graphically shows room sound coverage and speaker layout may be used to aid the configuration of the speaker(s) placement.

Optionally, the A/V device may include just the speaker cones and sound cards from the pairs of speakers to avoid bulkiness of the plastic casings. The speakers may be located on the sides and the back of the A/V device with an downward tilt of substantially 7°. In some embodiments, the angle for the tilt may be based on a visual estimate of 7°. The tilt angle is selected based on optimal sound wave dispersion to be used when mounted from the ceiling. A more acoustically savvy approach for speaker placement may be implemented. For example, a sound engineering software program that graphically shows room sound coverage and speaker layout may be used to aid the configuration of the speaker(s) placement.

### User Input Hardware

The A/V device discussed herein includes a user input hardware. The user input hardware may be a motion tracking camera and analysis system, such as Microsoft Kinect™ or other motion or gesture tracking by the web camera, monitoring finger movement on a surface (touch screen capability), tracking with an IR LED-based pointing device, or any combination thereof.

### Electric-Based Touch Screen

Traditional touch-screen technologies employ systems that use resistive, capacitive or surface acoustic waves to recognize a person's touch. The material required to implement such technologies for a 3 ft×4 ft projection is not only expensive, but would also add to maintenance and installation costs.

### Optical Touch Screen

Another touch screen technology that may be integrated includes the Community Core Vision (CCV). The CCV is an open source/cross-platform solution for computer vision and machine sensing. CCV takes a video input (typically from a commercial webcam), outputs tracking data (such as movement of finger) and events (such as when the finger is touching the surface and when it is not) to determine where a cursor or an interaction should be on a display screen.

In an embodiment of the A/V device, an inexpensive touchpad may be made using a webcam, a piece of Plexiglass, and a box. The touchpad may be made to any desired size. The steps used to make the device are as follows:
1. Download finger tracking application (e.g., CCV module) and mouse driver (e.g., TUIO);
2. Open the top of the box and cut a hole in the cardboard box. Tape the webcam to the center of the hole;
3. Connect the webcam to a laptop/a computer;
4. Place the glass on top of the box and a white paper on it;
5. Execute CCV module and optimize the CCV module to track finger movements; and
6. Run the mouse driver coupled to the CCV module.

To transform this touch pad into a touch-screen, an infrared camera, at least one source of infrared light, and a projector may be used. The IR camera that may be able to run off a USB port connected to the computing board 106.

A method of obtaining an infrared camera may be to make one from a webcam and a floppy disk using the following process:
1. Open the casing of a webcam to obtain the lens assembly;
2. Remove the top-most small piece of glass, such as by using a blade, which usually has a red tinge;
3. From the floppy disk, cut out two pieces of black photographic negative;
4. Put the pieces of negative in place of the removed glass; and
5. Reassemble the camera

Operationally, the modified webcam may be placed in the box of the touchpad. The projection surface (piece of Plexiglass) may then be flooded with a plane of infrared light from the sides so that CCV module can track fingers based on Frustrated Total Internal Reflection (FTIR). The light from the sides of the plexiglass gets trapped in it by internal reflection. A touch from a finger then causes the surface to be frustrated, sending infrared light perpendicular to the surface, i.e., towards the camera. If an image is projected onto the surface of the glass, the infrared camera may see and track the fingers moving on the surface.

### IR Source Input

Another input hardware to use may involve an infrared camera together with a source of infrared light enclosed in an IR emitter pen. In that example, high performance infrared camera inside a Wii™ remote can track sources of infrared light. An IR camera device, similar to a Wii™ remote, enables the transformation of any projection surface onto a digital whiteboard. By obtaining an IR camera and constructing a custom infrared emitter, a remote whiteboard may be implemented as the A/V device's user input.

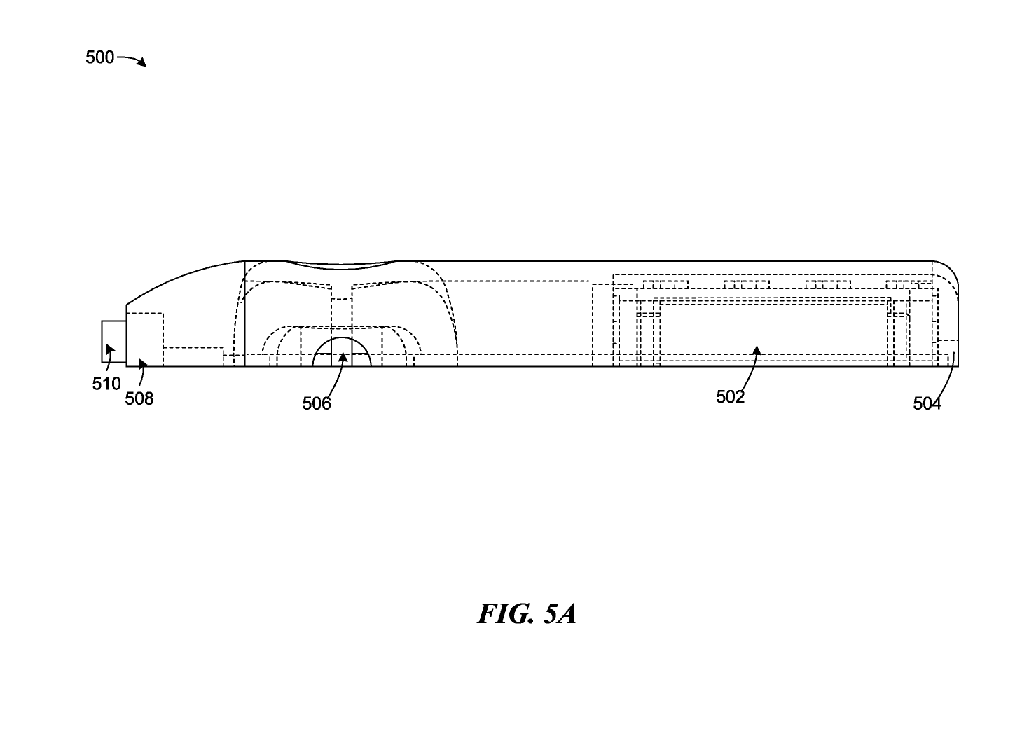

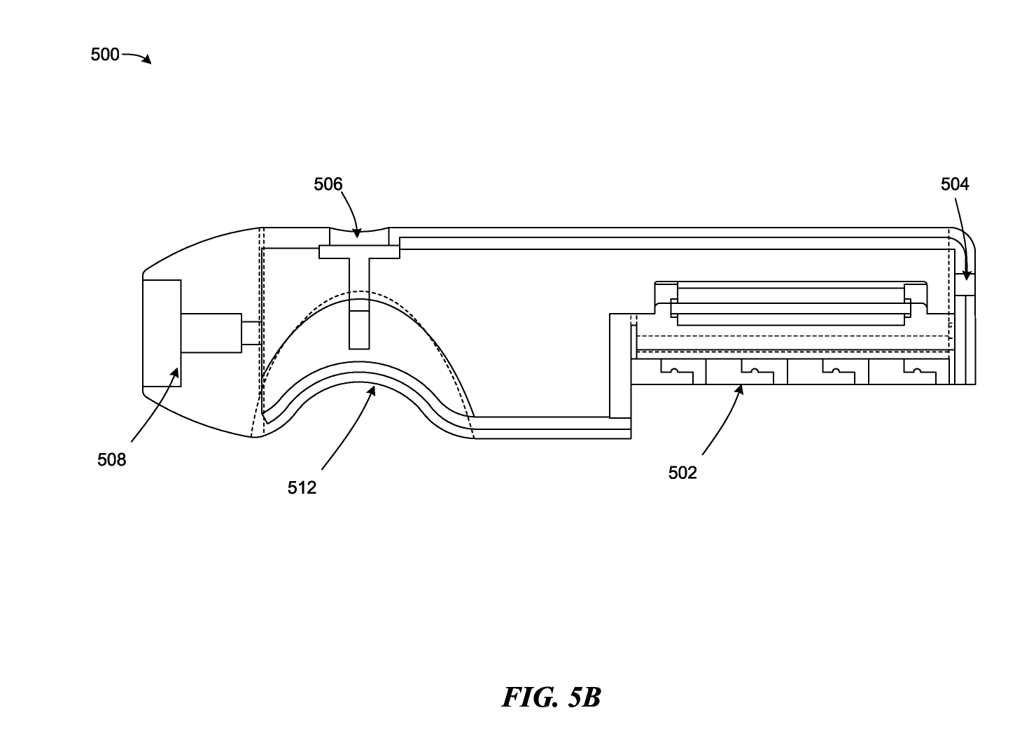

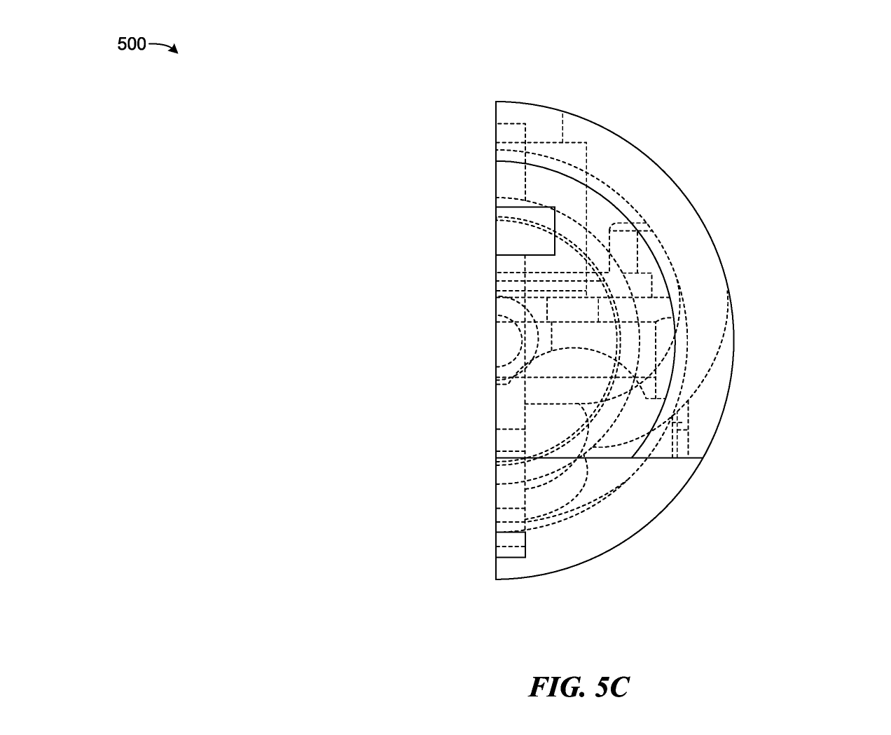

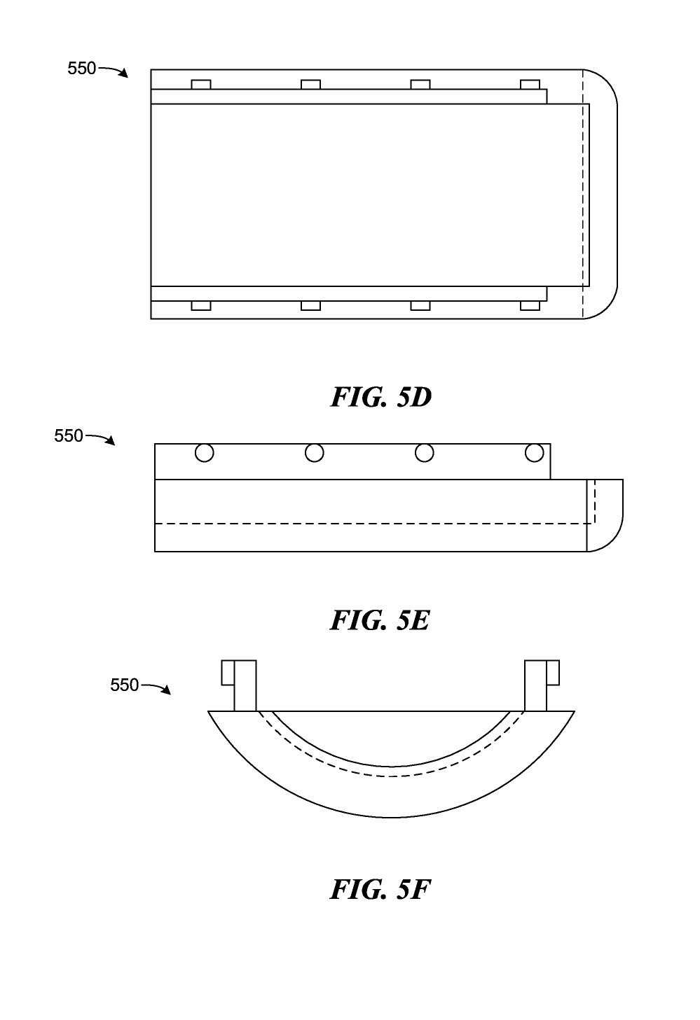

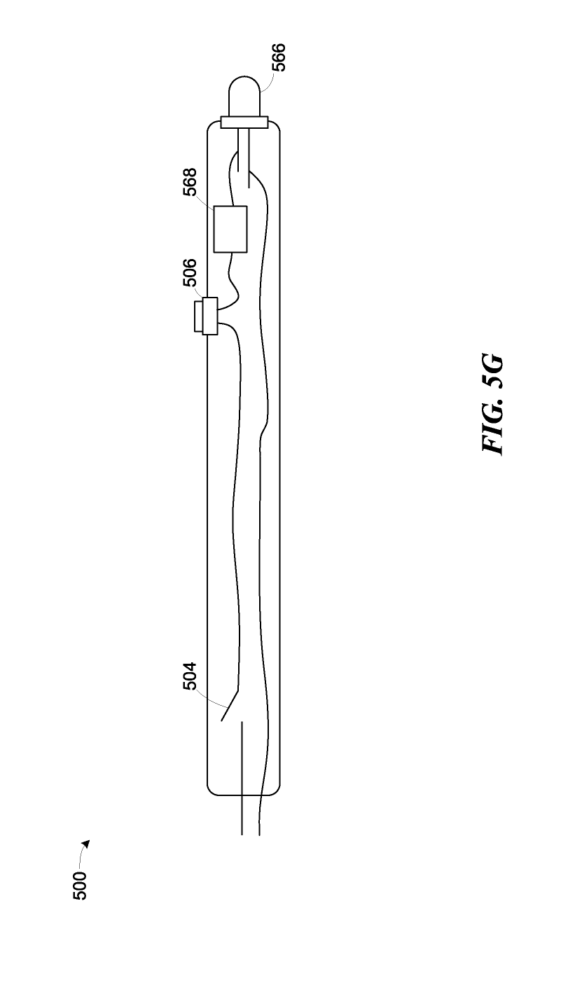

An IR emitter may be an IR emitting pen as illustrated in FIGS. 5A-F. FIG. 5A illustrates a side view of a first embodiment of an IR emitter 500 used in conjunction with the A/V device, such as the A/V device 100. The IR emitter 500 includes a battery compartment 502 to store an energy source for the IR emitter 500. The battery or batteries in the battery compartment 502 may be coupled to an on/off switch 504. The battery or batteries may also be coupled to a timer (not shown) that is activated by a click button 506. At a tip end of the IR emitter 500 is a LED compartment 508 where one or more LEDs are placed and coupled to the timer and the battery or batteries. Optionally, the LED compartment 508 may include a diffuser 510 that protrudes from the LED compartment 508 and emits light in a cylindrical fashion (360 degrees around the diffuser 510. In one embodiment, an end surface of the diffuser 510 facing away from the rest of the IR emitter 500 is coated to prevent IR light from exiting from the end surface, thus increasing the sideways diffusion of IR light.

FIG. 5B illustrates an example cross-section view of the IR emitter 500. FIG. 5B shows the battery compartment 502 exposed without a cover. The cross-section view illustrates an ergonomic cavity 512 on the body of the IR emitter 500 where a user of the IR emitter 500 may wrap his/her index finger into to secure the IR emitter device 500. In some embodiments, the IR emitter 500 includes a grip sleeve around its cylindrical body. In other embodiments, a grip surface is layered over the ergonomic cavity 512. FIG. 5C is an end view of the IR emitter 500.

FIG. 5D is a top view of an example battery compartment cover 550 of the IR emitter 500. FIG. 5E is a side view of an example battery compartment cover 550 of the IR emitter 500. FIG. 5F is an end view of an example battery compartment cover 550 of the IR emitter 500. The battery cover 550 may take on other shapes than illustrated. For example, the battery cover 550 may be a twist off cap end or a removable thumb screw.

FIG. 5G is a circuit diagram view of the IR emitter 500. The circuit diagram illustrates the on/off switch 504 and the click button 506 as described above. The circuit diagram further illustrates an IR LED 566, such as the IR LED to be placed within the LED compartment 508. A modulation circuit 568 is activated when the click button 506 is pressed, causing the IR LED to pulse at a pre-determined frequency or a pre-determined pattern, such as repeated pulses.

For example, the IR LED may be the QED233 by Fairchild Optoelectronics Group. However any through-hole IR LED can be implemented. Value of the resistor to be added in series=(Input Voltage−Drop Voltage)/(Forward Current). For example, an input voltage of 1.5 V from an AA battery may be used. The values of Drop Voltage and Forward Current may be found in a datasheet of the LED used. For example, a forward current of 100 mA and a drop voltage of 1.5 V may be indicated on the datasheet, thus making a resistor unnecessary. Since infrared light is invisible to the human eye, a webcam or a phone camera can be used to see if the LED is on.

To avoid leaving the pen on at all times, a circuit break may be introduced using a one-way switch. A software module may be included, as described below, to track the infrared light from the LED in order to move the mouse. In order to click, the LED light may be turned off momentarily. To accomplish this, a pushbutton that is normally closed (NC) may be placed in series with the circuit. Such buttons are alternatively called Mom-on, i.e., they are switches that always keep the circuit closed but break it momentarily when pushed down.

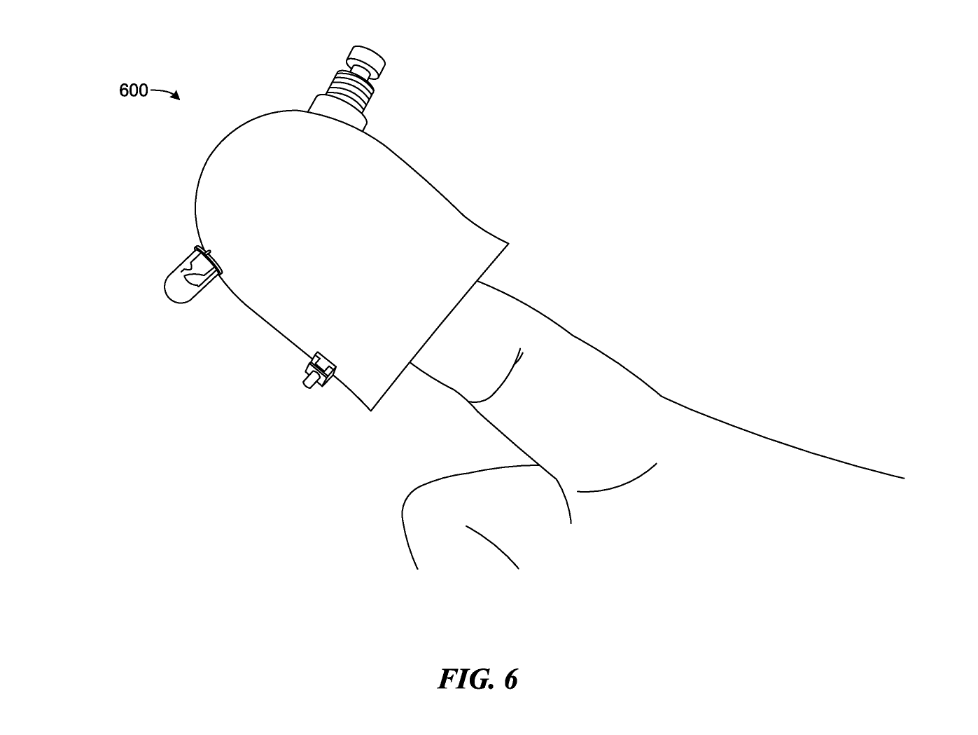

Another embodiment of the input hardware may include an IR source in the form of a finger cap as shown in FIG. 6. This example of the input hardware has the same components as the example of the IR pen. The cap may be designed on computer aided design (CAD) and made using rapid prototyping or 3D printing. The IR pen and the finger cap may be designed with ergonomic handles that contours around a human hand.

To determine the correct ergonomics of the user input method, clay may be used to make a shape that fits both left and right handed people. The input hardware, such as the IR emitter pen, may include a provision to place a button under the user's thumb. The input hardware may also have a tilted tip so that the LED is pointed in the range of view of the IR camera. The input hardware may further have a sleek design for comfort and ease of movement.

Once the IR emitter pen or finger cap is made and tested with a tracking software module, the entire set up (shown in FIG. 6) may be assembled. Unintended clicks when the IR LED goes out of sight from the IR camera may be resolved by modifying the hardware to not register the clicks when the IR source is not within sight. For example, the IR LEDs with different dispersion angles may be selected to derive at a more sophisticated detection of ‘click’.

TABLE 1
Example data for wide-angle LEDs

| | Viewing | Radiant | Drop | Forward | Series |
|---|---|---|---|---|---|
| LED part | Angle | Intensity | Voltage | Current | Resistor |
| number | (°) | (mW/sr) | (V) | (mA) | value (Ω) |
| VSMY1850 | 120 | 5 | 1.65 | 100 | 7.5 |
| VSMY7852x01 | 120 | 42 | 1.8 | 250 | 2.4 |

In one embodiment, the LED used has a 40° viewing angle and a radiant intensity of 10 mW/sr. Other embodiments may use one or more of the LED types in Table 1. LEDs with larger viewing angles is preferable because increasing the viewing angle increases tilt tolerance and minimizes unwanted clicks. Because these LEDs have larger viewing angles, these LEDs also consume more power. The viewing angles, radiant intensity, drop voltage, and forward current for these LEDs are listed in Table 1. Since the drop voltages are higher than 1.5 V, two AA batteries are needed to power these LEDs. The series resistor required can be calculated using the equation above. Power rating on the resistor can be calculated using P=I²R.

Once the LEDs and their respective resistors are mounted on circuit boards, the IR camera may be connected to make sure that the IR camera could track the wide angle LEDs and that the LEDs have a tolerance to tilt. Calibration testing may be accomplished by calibration LEDs mounted on a projection surface.

In the preferred embodiment, a click is detected by a module, such as a software module, when the LED is pulsed at a predetermined frequency. The click detection module coupled to the IR camera can then detect pulsing of the LED, at this frequency, to signal a click. This will ensure that, if the LED is out of view of the IR camera, unintended clicks are avoided.

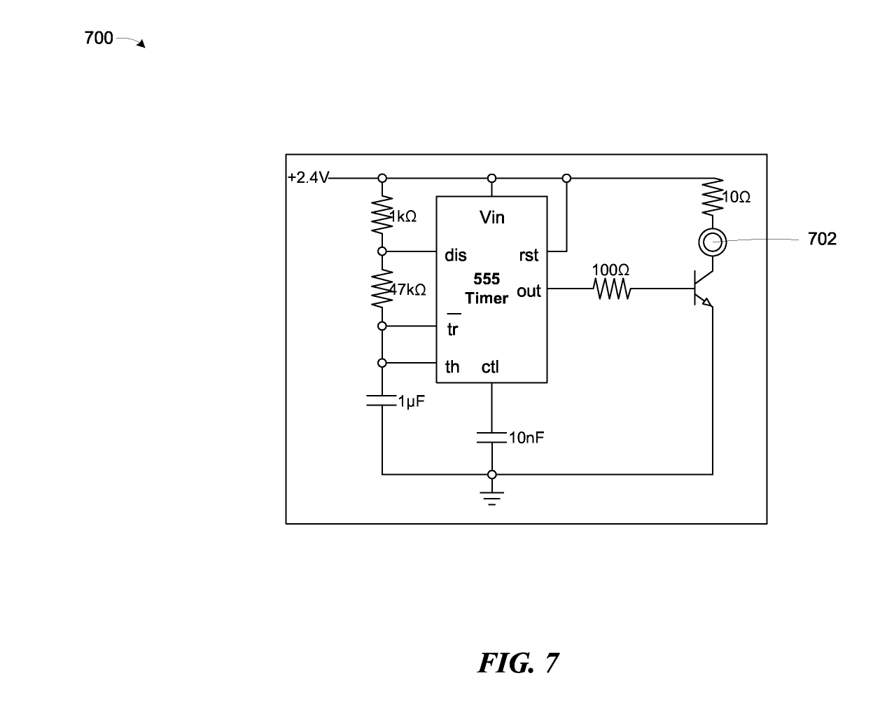

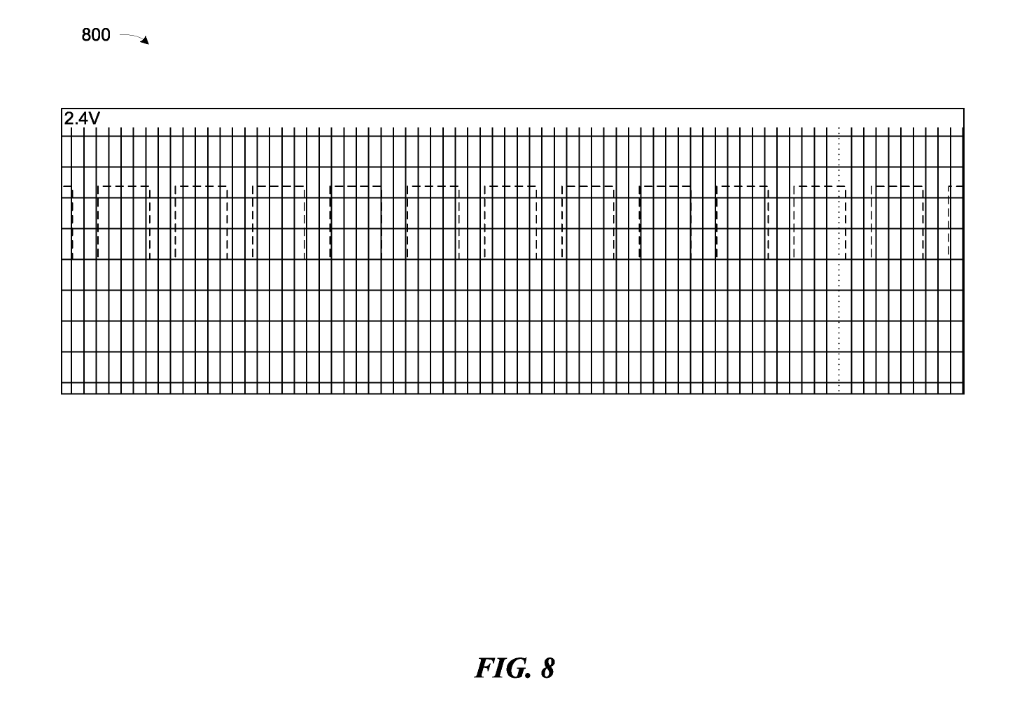

Pulsing of the LED was achieved by using a timer, such as a 555 timer. The schematic of the 555 timer operating a LED 702 is shown in FIG. 7. The output of the timer is illustrated in FIG. 8. In a specific embodiment, the 555 timer used can be the Texas Instrument TLC555CP. In the specific embodiment, the timer cannot source more than 10 mA, and thus more current is required to drive the LED. Hence, an npn-transistor may be used on the output to source necessary current (of 100 mA for QED233 part). The output voltage (as seen on an oscilloscope) from the configured 555 timer may vary between 2.4 V and 0 V. This behavior is useful because, when the output is 2.4 V, the npn would be in the forward active region. This state allows the required current to flow from the collector to the emitter, turning the LED on. When the output is 0 V, the transistor will be in the cut-off stage, and the LED will be off. The frequency of pulses from the timer is thus the same as the frequency of LED pulsing.

Note that for this embodiment, the simple on-off switch can be used but a different pushbutton should be used. The pushbutton can keep the LED on at all times, except when it is depressed. A button that connects two different circuits in a momentary way may be a Dual-Pole Single Throw (DPST) switch with momentary action (on-mom, off mom).

The timer and the DPST switch may be coupled together on a circuit board. The timer may be tuned so that the IR camera may be sensitive enough to recognize the pulsing. The hand held user input device may be powered from rechargeable batteries so that the batteries do not have to be replaced.

### Processor and Operating System

The A/V device may be implemented with a processor-based system including a processor running an operating system. The processor board of the processor-based system, such as a computer motherboard, may include Arduino, Beagleboard, Pandaboard, Intel x86 boards, or any combination thereof. The operating system may include any Linux operating system and any Android operating system.

In an alternative embodiment, the processor-based system used is an SBC (single board computer) where the SBC may offer the capabilities of a fully functional computer on a board. These SBCs have a variety of input and output options, and a powerful processor that can handle video with ease. They have the flexibility to install different operating systems and use any development platform.

The A/V device may use either an Android-based operating system or a Linux-based operating system.

### Single Board Computer

TABLE 2
Pros and cons of examples of SBCs
SBC Methodology

| | Beagleboard | Pandaboard | Intel x86 |
|---|---|---|---|
| Pros | Inexpensive | Inexpensive | Uses standard x86 |
| | Multiple video | Ubuntu supported | instruction set for |
| | outputs | Integrated | processor |
| | Lots of USB | Bluetooth/WiFi | Smooth migration |
| | ports | HDMI/DVI video-out | from development |
| | | | laptop |
| Cons | Texas Instruments | Difficulty with some | Expensive |
| | Cortex A8 1 GHz | drivers (OMAP4) | |
| | processor | Limited video-out | |
| | No built-in | options | |
| | Bluetooth/WiFi | | |

Different boards including at least three types of boards in Table 2 are possible for the processor-based system of the A/V device: the Beagleboard, the Pandaboard, and a standard Intel x86 based board. Table 2 describes the benefits of each. The Beagleboard may offer high functionality at a low cost. It could be difficult to transfer the developed package onto the board because the board uses a Texas Instruments Cortex A8 processor. Such a processor does not follow the standard x86 instruction set, which means that installing something as generic as the standard Ubuntu Linux build could be problematic. A board with either an Intel processor or something compatible with the x86 instruction set would cost significantly more than the Beagleboard.

The preferred embodiment for the computing device is a Pandaboard, which is in the same price range as the Beagleboard. Functionality is very similar to the Beagleboard, except the Pandaboard also includes integrated WiFi and Bluetooth. The processor is an ARM OMAP4 processor (not the recommended Intel processor), but has specifically been designed to run the standard Ubuntu build. The Pandaboard can feature a 1 GHz dual-core processor, 1 GB low-power RAM, and full HDMI 1080p video-out.

In a preferred embodiment, the processor-based system is a Pandaboard running the Linux build, Ubuntu. An alternative to the Pandaboard may run based on less than 15 W (the power allotted for the SBC in the device). For example, a low-power, fan-less PC called the T1, produced by Aluetia may be used as an alternative. The T1 features: passive CPU cooling (fan-less), low-power (12 W) consumption, and an access point mode, which allows computers to receive and broadcast wireless signals to other computers. In addition to the features above, the T1 includes a 1.6 GHz Intel processor, 2 GB RAM, VGA and DVI outputs, and Linux compatible connectivity chipsets. Another viable alternative is the Raspberry Pi.

### Chassis/Casing

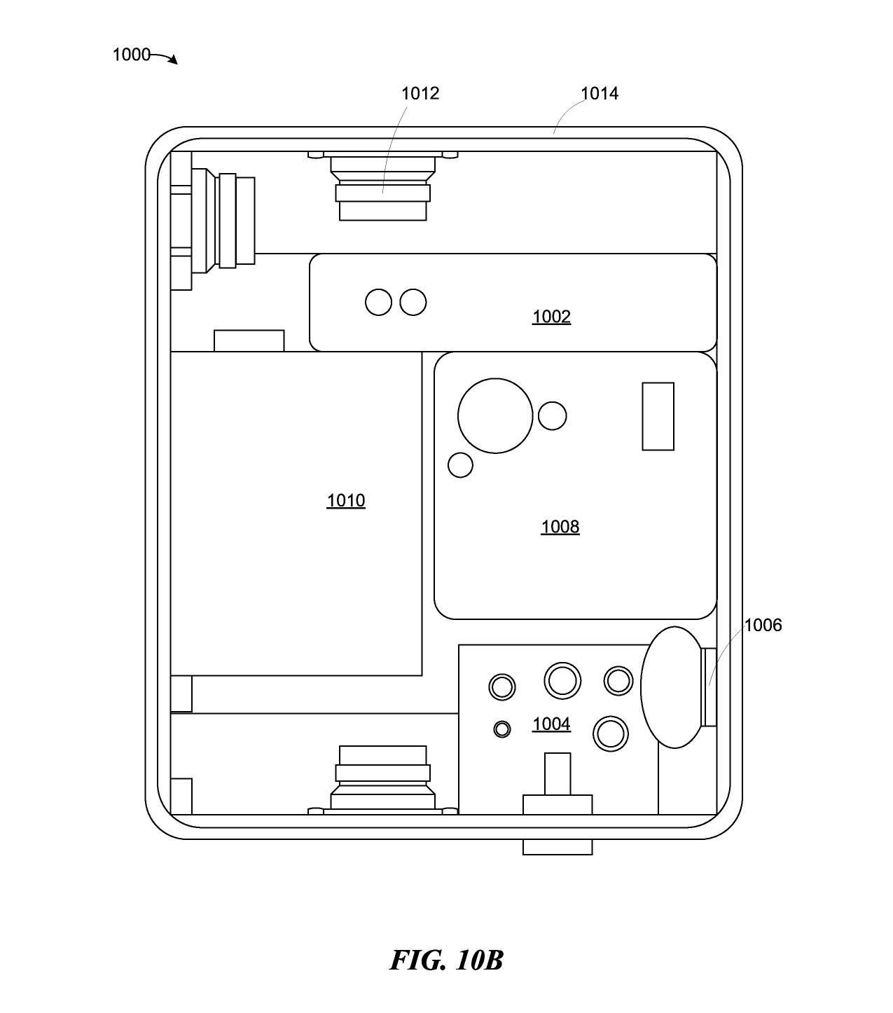

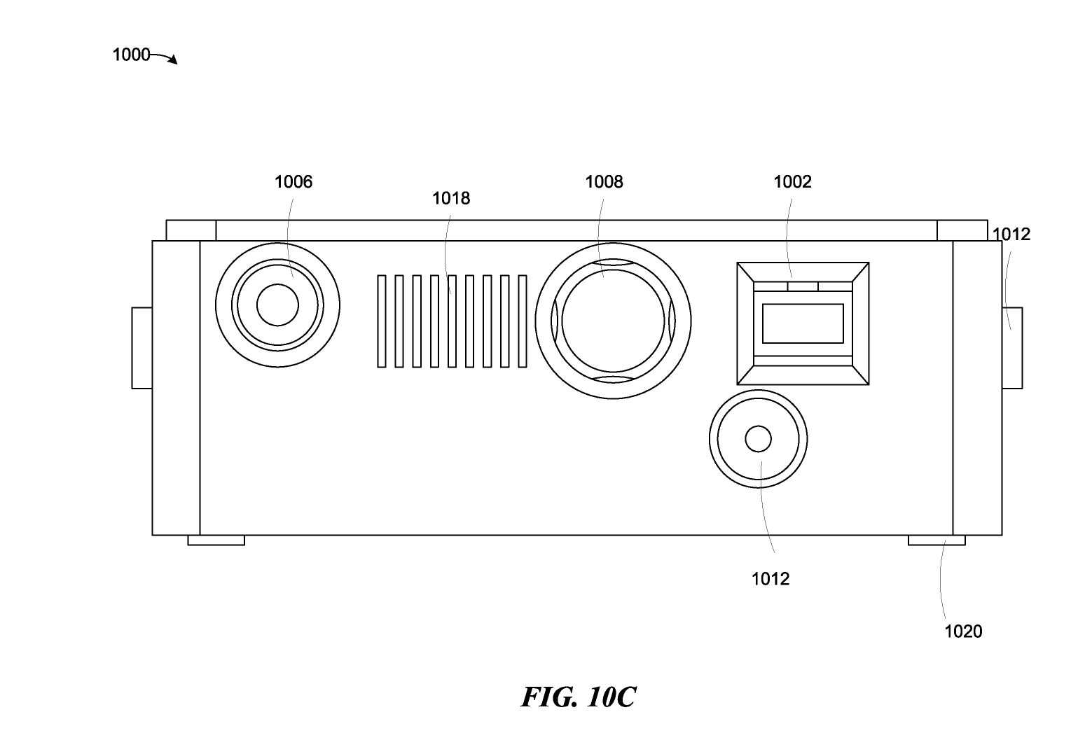

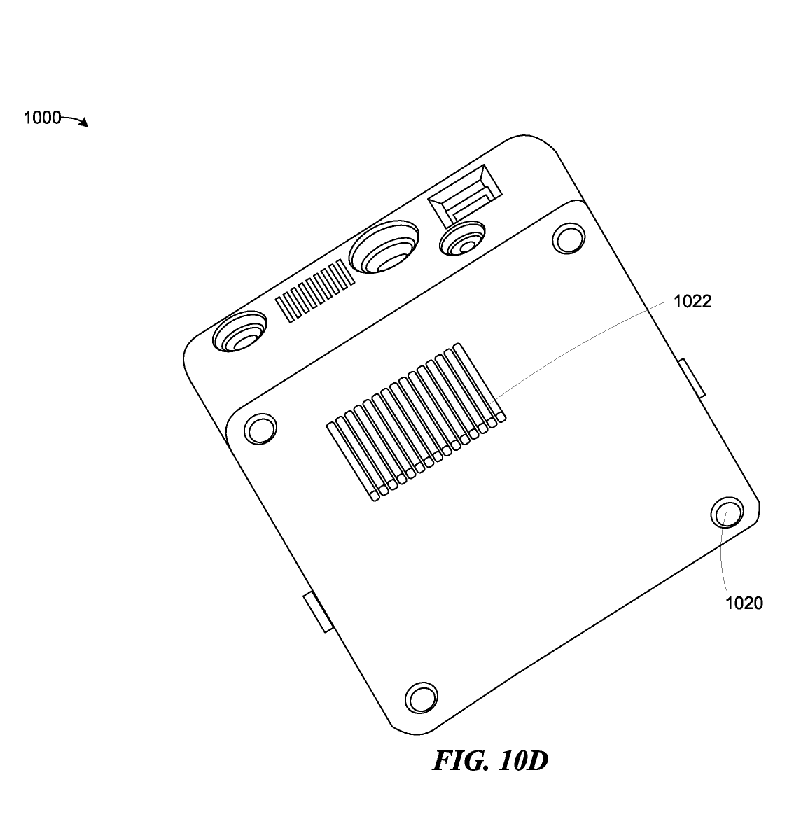

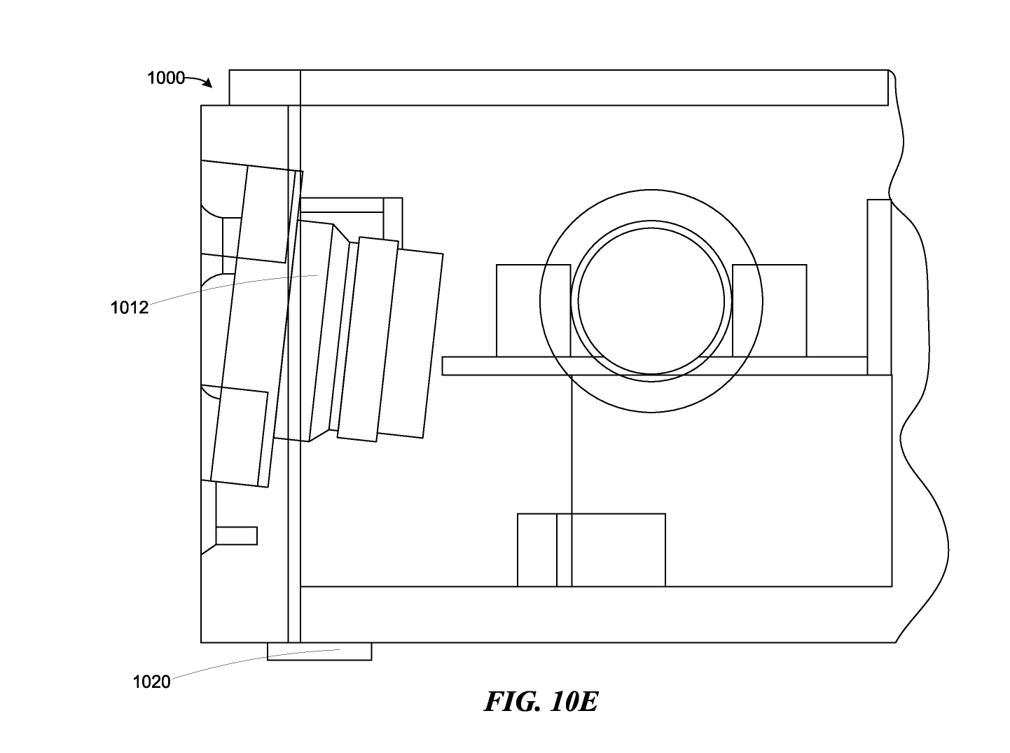

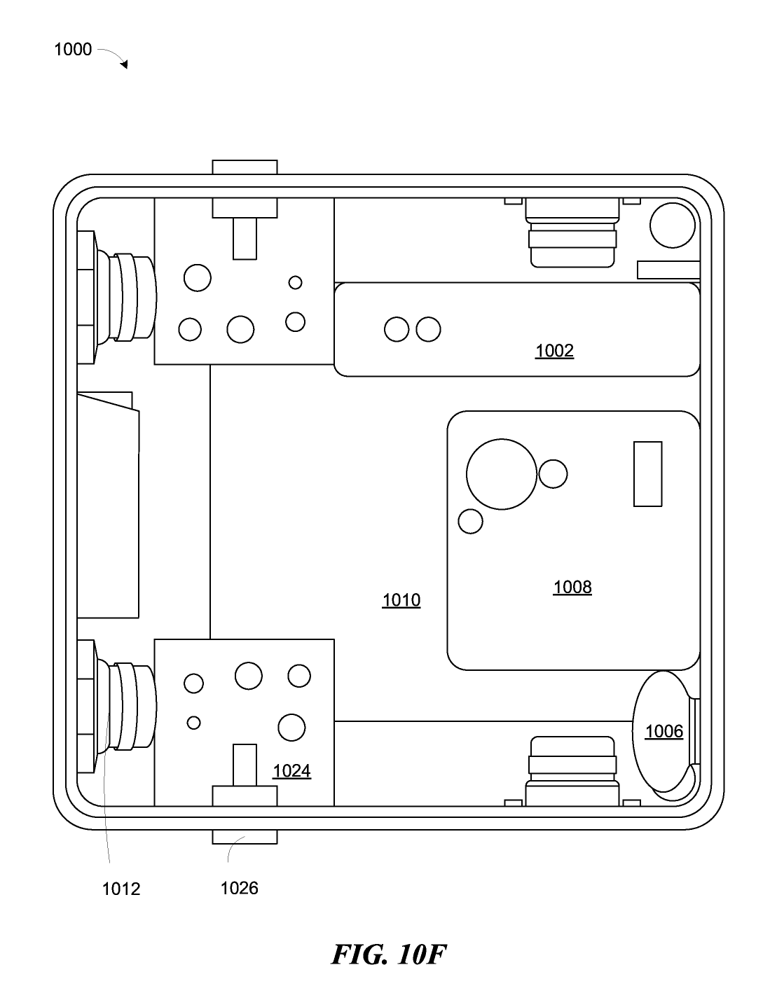

In a preferred embodiment, all of the components for the A/V device are enclosed in a single case, so the entire device is portable and rugged, and can be used for demonstration purposes. The casing can be modeled in SolidWorks and printed on the rapid prototyping machine, such as a 3D printer. Considerations when designing the casing included: how to align the projector, IR camera (e.g., a Wii™ remote), and webcam to have parallel lines of site, sufficient ventilation, and speaker mounting to produce desirable acoustics. Examples of the assembly of the casing and components are illustrated in FIGS. 10A-F.

FIG. 10A is a top perspective view of components of an A/V device 1000 prior to assembly. For example, the A/V device 1000 can be the A/V device 100 of FIG. 1 or the A/V device 200 of FIG. 2. The A/V device 1000 includes an IR camera 1002, a power supply 1004, a web camera 1006, a projector 1008, a computing apparatus 1010, a speaker 1012, or any combination thereof. The components of the A/V device 1000 may be secured onto a chassis box 1014. The top perspective view illustrates one example configuration of the components within the A/V device 1000. An on/off switch 1016 to the A/V device 1000 may be exposed on the chassis box 1014. The on/off switch 1016 may be coupled to the power supply 1004 with any combination of the components of the A/V device 1000 to synchronously turn off all of the components within the A/V device 1000.

It is noted that the web camera 1006 is a general video camera that may be connected to the computing apparatus 1010. The web camera 1006 may include a microphone for audio input as well as video input. The web camera 1006 does not require a web connection in order to operate.

FIG. 10B is an example top view of components of the A/V device 1000 after assembly, where a top cover of the chassis box 1014 is removed. The top view may illustrate another example configuration of the components of the A/V device 1000 different from the top perspective view. For example, the A/V device 1000 may include the IR camera 1002, the power supply 1004, the web camera 1006, the projector 1008, and the speaker 1012 mounted on a side of the chassis box 1014. The camera sensor of the IR camera 1002 may be exposed to the outside of the chassis box 1014. The battery input of the power supply 1004 may be exposed to the outside of the chassis box 1014. The camera sensor of the web camera 1006 and an associated microphone (not shown) may be exposed to the outside of the chassis box 1014. The projection lens of the projector 1008 may be exposed to the outside of the chassis box 1014. The sound making surface of the speaker 1012 may also be exposed to the outside of the chassis box 1014.

FIG. 10C is an example side view of components of the A/V device 1000. The side view may illustrate another example configuration of the components of the A/V device 1000 different from the top perspective view or the top view. For example, the A/V device 1000 in the side view illustrates the IR camera 1002, the web camera 1006, the projector 1008, and the speaker 1012 exposed from the chassis box 1014. Different instances of the speaker 1012 may be attached to different walls of the chassis box 1014. The side view illustrates a side vent 1018, such as the vent 218 of FIG. 2, where a fan (either inflow or outflow) may be attached adjacent thereto. The side view further illustrates device legs 1020 for leveling and pointing the A/V device 1000 when placed on a table top.

FIG. 10D is an example bottom perspective view of components of the A/V device 1000. The bottom perspective view may illustrate another example configuration of the components of the A/V device 1000 different from the top perspective view, the top view, or the side view. The bottom perspective view illustrates a bottom vent 1022 on a bottom side of the chassis box 1014. The bottom side of the chassis box 1014 also includes one or more legs 1020. The legs 1020, for example, can be adjustable legs for supporting the A/V device above a table top and allowing the bottom vent 1022 some spacing from the table top to circulate air.

FIG. 10E is an example partial side plan view of the components of the A/V device 1000. The partial side plan view may illustrate another example configuration of the components of the A/V device 1000 different from the top perspective view, the top view, the side view, or the bottom perspective view. The partial side plan view is a semi-transparent illustration of the A/V device 1000 from part of its side. The partial side plan view illustrates the A/V device 1000 with an instance of the speaker 1012 installed within a wall of the chassis box 1014 at a slight angle.

FIG. 10F is an example top plan view of the components of the A/V device 1000 with the top cover of the chassis box 1014 removed. The top plan view may illustrate another example configuration of the components of the A/V device 1000 different from the top perspective view, the top view, the side view, the bottom perspective view, or the partial side plan view. The top plan view illustrates two audio amplifier boards 1024 coupled to the speakers 1012. Each audio amplifier board may also be coupled to a volume adjust knob 1026 that is exposed through the chassis box 1014.

Part of the challenge to build a casing is aligning all the components while giving the SBC and projector sufficient cooling space. For example, the T1 SBC may be mounted facing up in the case; however, the IR camera and projector would be blocking its only air vent. To avoid this problem, the T1 may be mounted upside down, and a vent may be cut into the base of the casing. An additional vent may be added to the front of the casing for the projector. In order to reduce the space the speakers occupy, the individual speaker cones and sound boards may be removed from their respective cabinets, and slots may be cut into the casing to mount them. The speaker cones may then be tuned to have reasonable acoustics even when removed from their cabinets. Since one embodiment of the device is mounted towards the front of a classroom, two speakers may be mounted in the back and two on the sides to ensure adequate projection around the A/V device. In other embodiments, the speaker positions may be changed based on overall mounting specifications. Rear speakers may be mounted at an angle to improve acoustics, since the projector's tilt would naturally point the speakers towards the ground when the A/V device is set on a table, or towards the ceiling when the A/V device is mounted on the ceiling. Posts may be mounted on the bottom of the A/V device to hold adjustable feet that can tilt the projector approximately 10° from table-top parallel in any orientation. The feet also give the bottom vent sufficient clearance from the table.

### Video Recording Hardware

In order to add video recording capabilities to the A/V device, a webcam may be added to the A/V device. For example, a USB powered webcam may provide all of the functionality needed for reasonable video recording on the A/V device.

### Software

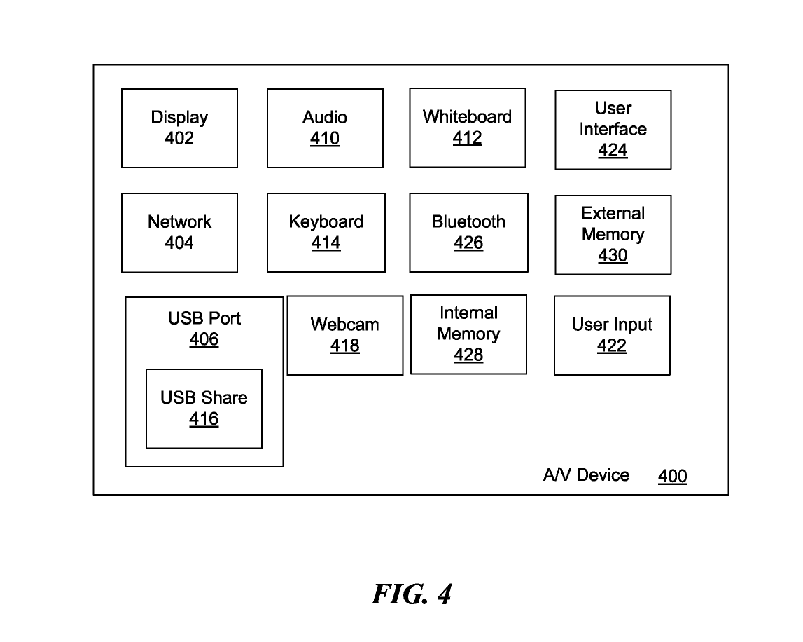

FIG. 4 is a block diagram of a further embodiment of the A/V device 400, such as the A/V device 100 or the A/V device 200. The modules described within the block diagram includes both hardware modules and software modules. The modules may be implemented as hardware components, software modules, or any combination thereof. For example, the modules described can be software modules implemented as instructions on a non-transitory memory capable of being executed by a processor or a controller on a machine. Software modules may be operable when executed by a processor.

For example, the A/V device 400 may include a display module 402, a network module 404, a USB port module 406, an audio module 410, a whiteboard module 412, a keyboard module 414, a USB sharing module 416, a webcam module 418, a user input module 422, an enhanced graphics/UI module 424, a Bluetooth module 426, an internal memory module 428, an external memory module 430, or any combination thereof. In some embodiments, one more of these modules may be accessed or updated without network connection via the network module 404.

Each of the modules may operate individually and independently of other modules. Some or all of the modules may be executed on the same host device or on separate devices. The separate devices can be coupled via a communication module to coordinate its operations. Some or all of the modules may be combined as one module.

A single module may also be divided into sub-modules, each sub-module performing separate method step or method steps of the single module. The modules can share access to a memory space. One module may access data accessed by or transformed by another module. The modules may be considered “coupled” to one another if they share a physical connection or a virtual connection, directly or indirectly, allowing data accessed or modified from one module to be accessed in another module. In some embodiments, some or all of the modules can be upgraded or modified remotely.

One or more of the modules may reside within a computing board, such as the computing board 106 or the computing board 208. One or more of the modules may also be a separate hardware component. One or more of the modules may be part of the discrete components of the A/V device 400.

The A/V device may include additional, fewer, or different modules for various applications. Components such as cellular network interfaces, security functions, operating system(s), and the like are not shown so as to not obscure the details of the system.

The display module 402 provides an interface between the computing board, such as the computer board 106 or computer board 208 of FIG. 2, and the projector, such as the projector 108. The network module 404 provides an interface for an Ethernet connection and/or an WiFi connection. The USB port module 406 provides an interface for the USB port of the computing board. The audio module 410 provides an interface between computing board and the speakers or audio amplifier circuit. The webcam module 418 provides an interface between the computing board and a web camera, such as the web camera 102. The Bluetooth module 426 provides a Bluetooth connection to the computing board. The internal memory module 428 and the external memory module 430 each provides access to storage memory for applications on the computing board, where the internal memory module 428 operates to manage internal memory and the external memory module 430 operates to manage removable external memory.

The enhanced graphics/user interface (UI) module 424 provides a user interface to run an interactive educational application. The user interface provides access to lesson selection, multimedia library, examination selection, Internet browser, white board selection, international educational material library, or any combination. The user interface may be a HTML graphical user interface with interactive elements that calls Python functions. The UI module 424 enables generation of an interactive browser with functions including web-browsing, scroll screen, refresh screen, home screen, listing playable/viewable files, and generating a projection screen keyboard. The listing can include playable/viewable files such as videos, classroom curriculum, and images available on on-board or portable memory

The whiteboard module 412 provides an interactive space for user input emulating a virtual whiteboard. For example, the whiteboard module 412 enables drawing on the projection surface with different colors and save these creations as images, to annotate files projected on the screen or otherwise to interact with applications running on the computer. The whiteboard module 412 enables a user to interactively take notes, draw pictures, or create diagrams on the projected screen with the input hardware. There may be a variety of different colors that the user can choose from, as well as an eraser option to modify existing work. When the user has finished drawing, the whiteboard contents can be saved and viewed at any time.

The on-screen keyboard module 414 enables a remote typing experience by displaying an on-screen keyboard through projection and allowing typing of individual keys through the input hardware. The on-screen keyboard may be optimized in the on-screen keyboard module 414 on the A/V device 400 such that the keyboard is sufficiently spread out for comfortable typing. When the input hardware is modulated/pulsed (button pressed) for the purpose of selecting a letter on a keyboard, the keyboard module 414 may be adapted to select the letter only once—not multiple times.

In one example, the keyboard spans the entire projection screen, and contained small keys with even smaller fonts. In a preferred example, the keyboard has large buttons with bold letters and consumes the middle two thirds of the screen. Thus, users can hit the keys with more accuracy and can reach the entire keyboard with ease.

The USB sharing module 416 provides a capability for content (including saved whiteboard drawings) to be shared between two audio-visual devices or between a A/V device and a computer. The USB sharing module 416 enables teachers to share what they have been using in their classes, and serves as a backup method for adding content to the device if there is no Internet connectivity. When the USB device is plugged in, its content is displayed in its own column next to the device's own content. Files can easily be copied back and forth or deleted from either location.

The webcam module 418 provides a pop-down camera control panel that can be accessed at any time during operation. Videos can be recorded, viewed, and shared with any other audio-visual device or generic computer. In one embodiment, the webcam module can provide a video conferencing feature.

In one embodiment, the user input module 422 calculates one or more user input position and interaction data from an IR pen via an IR camera to enable a user input tracking feature (similar to a remote mouse). In one embodiment, the user input module 422 is on the IR camera. In this embodiment, the user input module 422 can convert the image taken by the IR camera into one or more coordinates of IR sources in the image. For example, the IR camera may be a Wii™ remote. In that example, the user input module 422 may calculate up to four X,Y coordinates in the image detected by the IR camera. In some embodiments, multiple IR sources may be utilized at the same time and the user input module 422 may tracked each IR source individually and provide separate X,Y coordinates for each IR source. The multiple coordinates may be tracked by detecting base modulations of the IR sources, where a different base optical modulation, such as a pulsing frequency, is used for each IR light source. When a mouse button is pressed, a further modulation/pulsing is added on top of the base modulation of each IR source.

In another embodiment, the user input module 422 resides on a computing board external to the IR camera. In this embodiment, the user input module 422 receives the video or discrete image stream from the IR camera, and calculates coordinates of IR sources in the video or discrete image stream.

In some embodiments, instead of calculation a X,Y coordinate, the user input module 422 may calculate three-dimensional coordinates of the IR source(s) detected. In various embodiments, the user input module 422 may be able to use homography to calibrate the IR source(s) given any obscure angle of the projector.

The user input module 422 can be adapted to pair with the IR camera via Bluetooth or through wired connection. The user input module 422 can receive tracking data from the IR camera. The user input module 422 may track the IR dot and click at the location where the dot flashed. The user input module 422 may implement a clicking interpretation technique in order to differentiate between a pulsing IR signal and a solid one.

The pulse rate of the pen, sampling frequency of the IR camera, and the clock time of the computer can be synced in the configuration of the A/V device 400 to achieve consistent pulse detection by the user input module 422. For example, as part of configuration, the fastest frequency to pulse the IR pen can be found and stored, so that the IR source would send multiple pulses every time the click button was actuated, while the pulses are still detectable by the user input module 422. The faster the pulse, the less likely a user would accidently induce clicks by blocking the IR camera's view for a split second. Other error detection and correction of false positive clicks or missed clicks may be implemented in the user input module 422.

### Power Management

In one embodiment, the battery of the A/V device may be a 12V 120 amp-hour deep cycle battery. Although the lifespan of a deep cycle battery depends on how it is maintained and charged, the average lifespan of the battery in this embodiment may be 4 to 8 years and can be discharged to 20% of its capacity. Depending on technology of battery used, different battery life and discharge rate may be observed. In practice, the cutoff of battery life in general is the minimum allowable voltage output, and not a monitoring and summation of Amp-hr output.

The amount of current pulled by each component parts can be estimated to ensure the amp-hour rating required to power the device matches the battery. The single board computer may be rated to have a maximum power consumption of 23 W, the projector may be rated at 65 W, and the speakers may be rated at a peak of 12 W. The total power consumption may thus be 100 W. Because the battery is 12V, the battery thus needs to supply 8.33 A. For the entire device to run for 6 hours, the Amp hour rating should be ≧50 Ah. Thus a 12 V deep cycle battery with a 120 Ah rating would be sufficient to handle the load of the components of the A/V device to run for an educational session that is approximately six hours long.

### Inverter

In order to power the A/V device by the battery, an inverter and a converter can be used. For example, a TrippLite PowerVerter® 150 W Ultra-Compact Inverter may be implemented to run the speakers along with the SBC board setup, the webcam, and IR camera. For example, a Dell DC adaptor may be used to run the projector directly off of the 12 V battery.

In one embodiment, the inverter is rated at 150 W. The inverter can supply 45 W as required by the SBC setup and 12 W as required by the speakers. The inverter's maximum output current is 150 W/12 V=12.5 A. Therefore, the inverter should be sufficient to power the attached components. Examples of power test measurements taken using a Kill-A-Watt meter, oscilloscope, differential probe, and current probe setup are shown below in Table 3.

To avoid a potential unanticipated shutdown due to current spikes in the speakers or difference between real and apparent power, an additional converter may be implemented. In order to run the device off the battery, the power consumption loads may be split with 0.45 A running off the inverter and 0.68 A running off a DC converter.

TABLE 3
Test Power Measurements. This table delineates power measurements
for all device components. Power is measured in Watts and current
in Amps. The dimensionless power factor is also measured.

| Component | Watts | Amps | PF |
|---|---|---|---|
| SBC with Wii ™ Remote and Camera | 15 | 0.23 | 0.57 |
| Projector | 41 | 0.68 | 0.5 |
| Speakers (2) | 5.78 | .06054 | .80 |

*All voltages are 119.8 V

While all of the components can run off of the battery by connecting the inverter and converter to the 12 V battery, this setup may be an inefficient way to power the A/V device. Efficiency may be lost in the conversion from the battery's DC to the inverter's AC and then back to component's DC. Hence, in some embodiments DC-DC converters may be implemented.

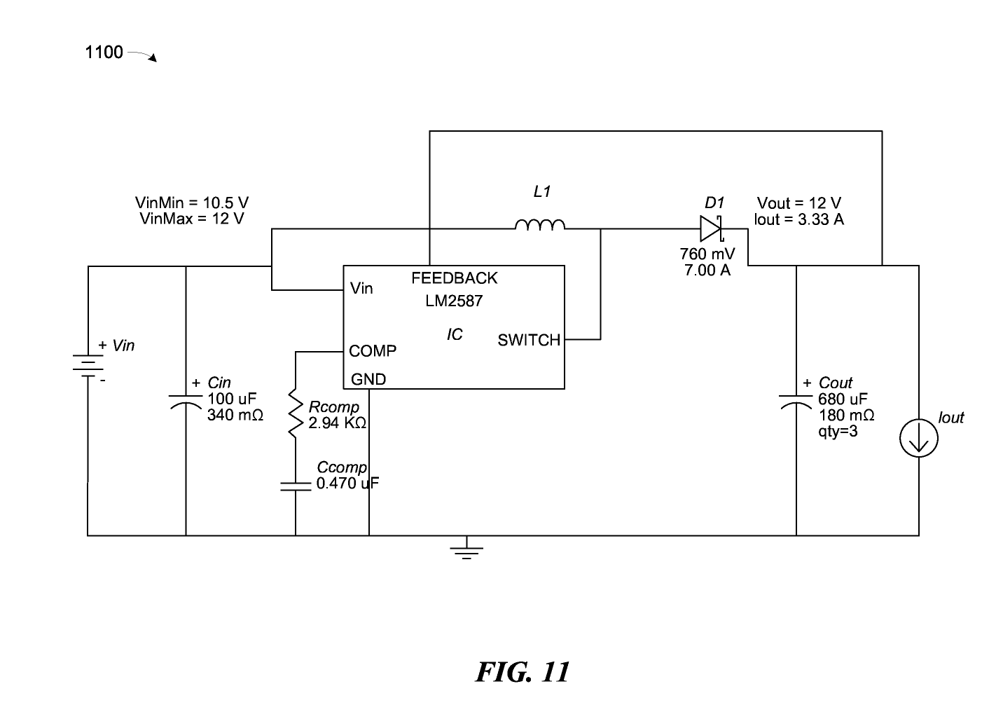

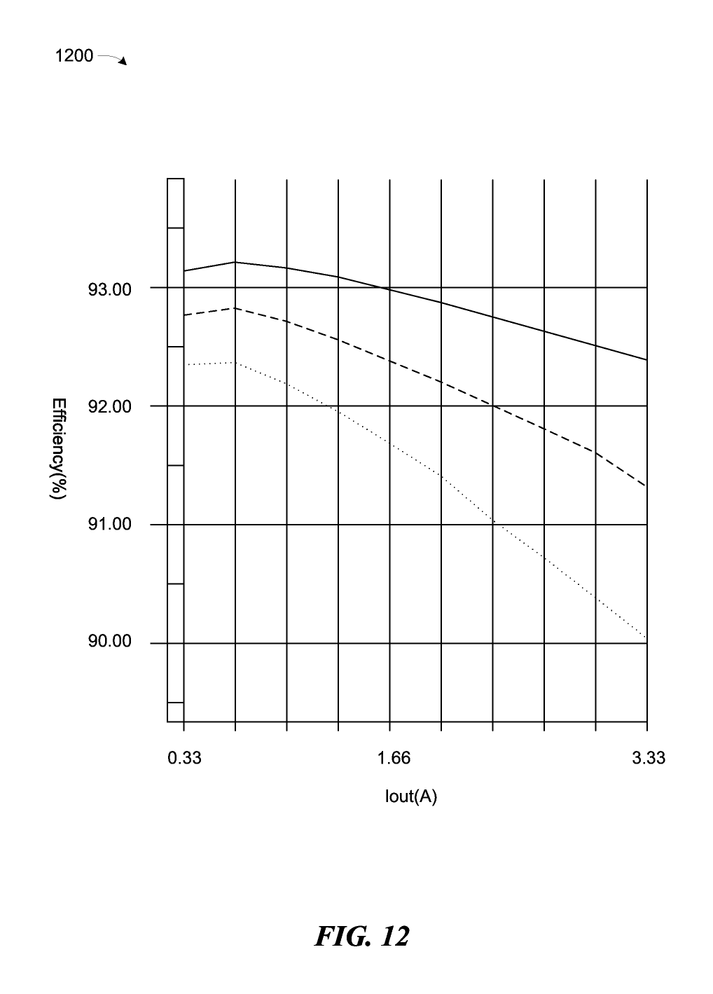

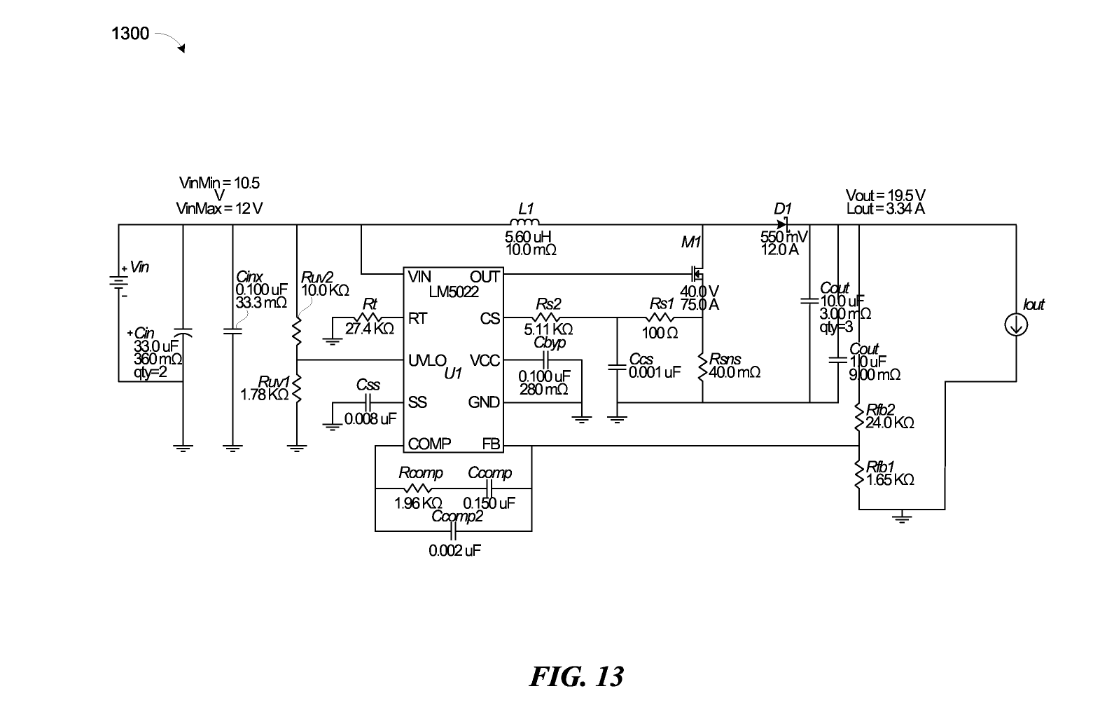

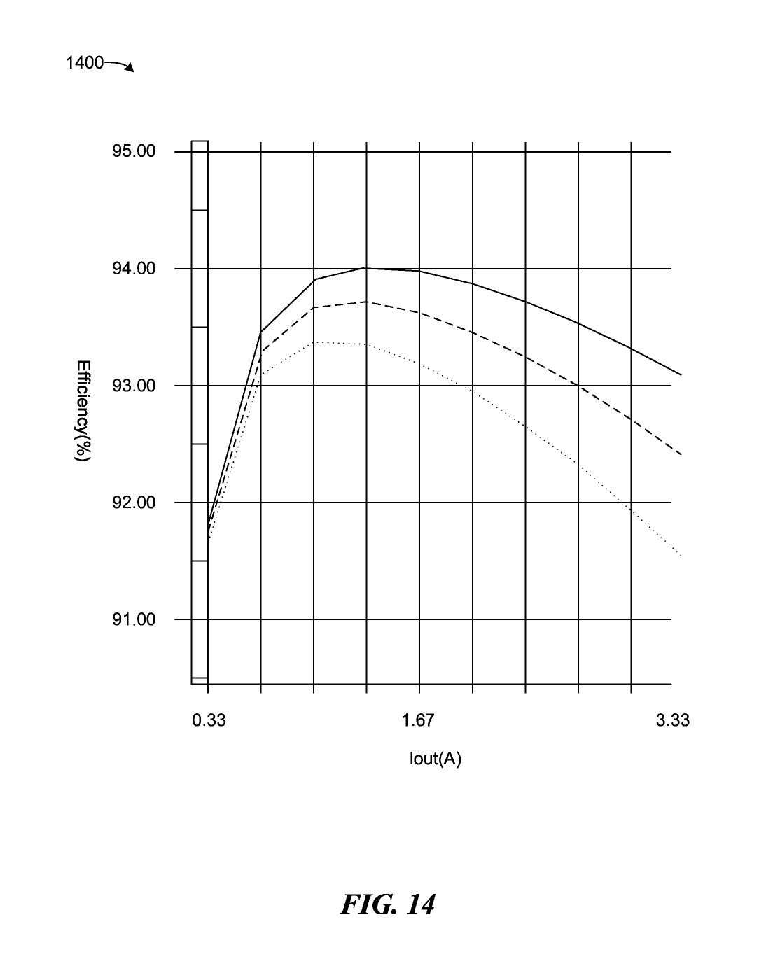

Power management software may be used to determine the appropriate DC-DC converters designs. The speaker adapter may be rated at 10 V and 0.5 A. To convert from the 12 V battery, a DC-DC buck converter may be used. The maximum efficiency in this embodiment is at an operational current less than the peak 0.5 A. The single board computer is rated at 12V and 3.33 A. A flyback regulator may be used to get the output from the battery. An example of a flyback regulator 1100 is illustrated in FIG. 11. The projector may be rated at 19.5V and 3.34 A. A high voltage boost converter may be used for this application. An example of the boost converter is illustrated in FIG. 13.

The A/V device and/or the input hardware, such as the IR emitter, may include an energy-saving module to extend usable time of the battery. The energy-saving module may include a time-out function for the projector, the SBC, the input hardware, or any combination thereof. The energy-saving module may also provide user-initiated ‘sleep’ commands to the same components or the whole A/V device.

In some embodiments, connection to the Internet through a mobile data network may exist, but can be limited where uploads and downloads have to take place when the A/V device is in a power-saving mode or sleep-mode. Even though the connection may be slow, this is a very efficient way to transfer in/out content and for individual schools to exchange content with others. The mobile data network capability may also be on during power-saving or sleep-mode for system managers to monitor the use of the A/V device and/or monitor the status of the power system of the A/V device.

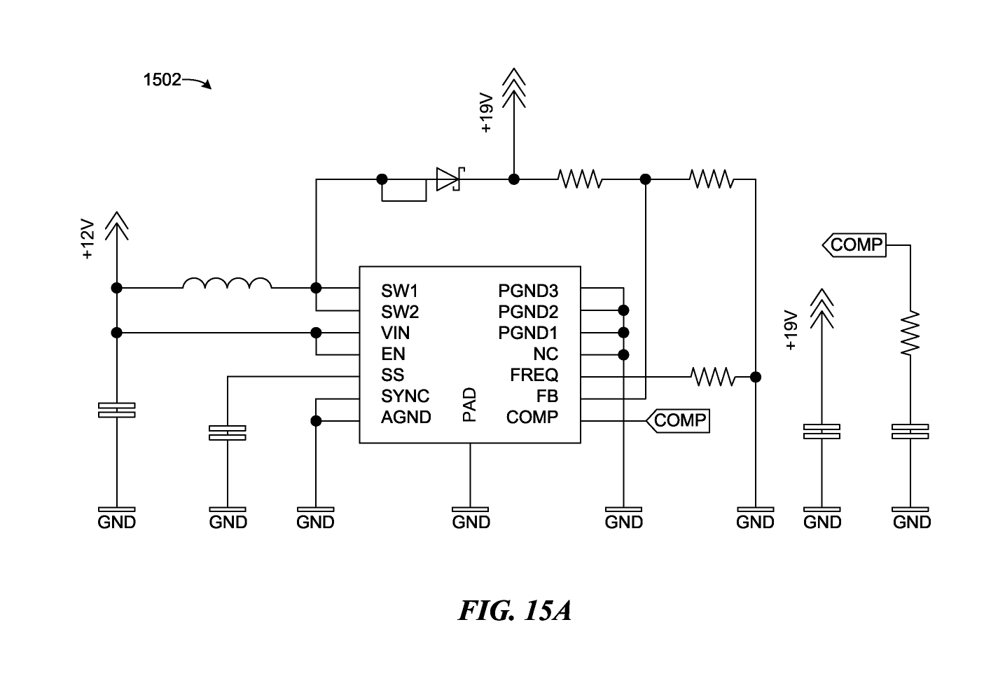

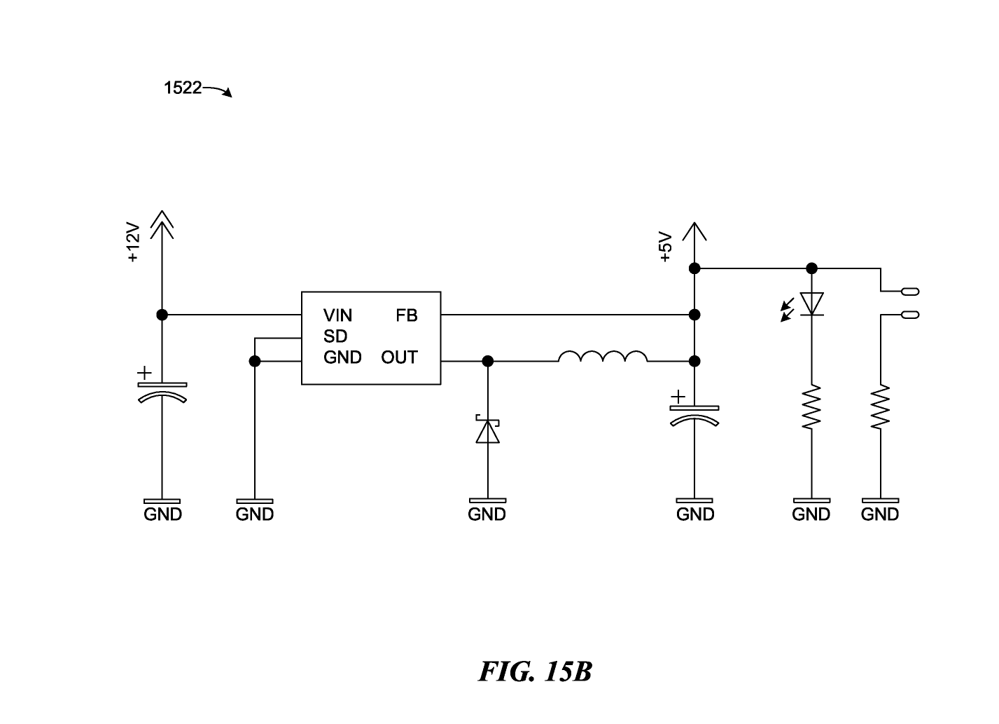

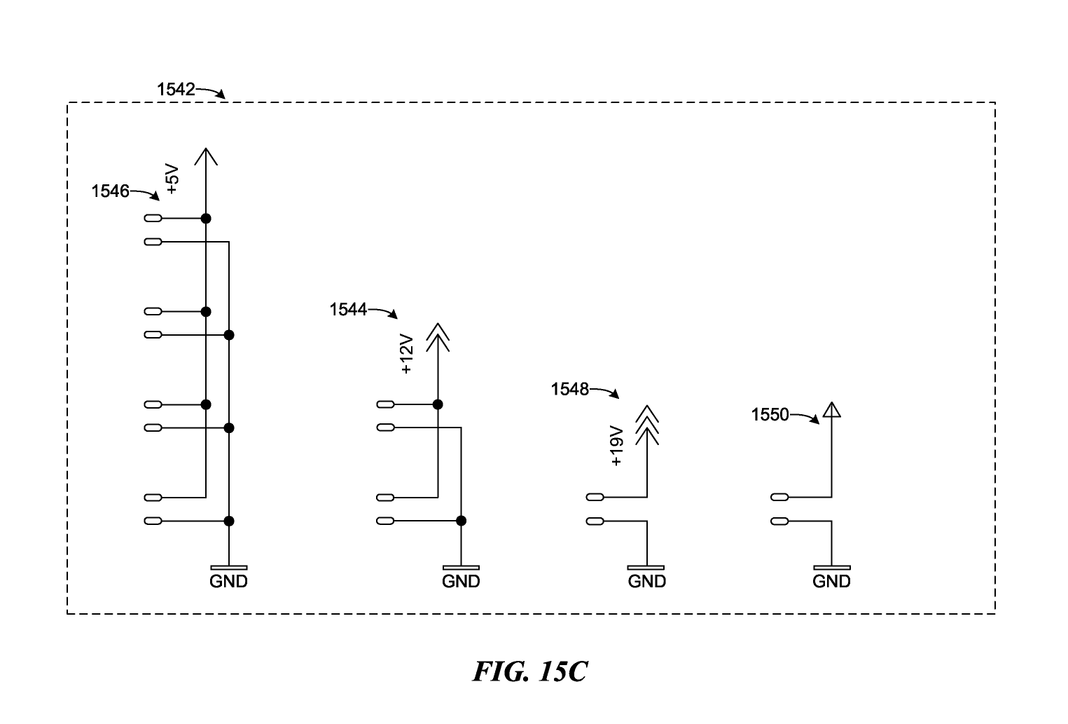

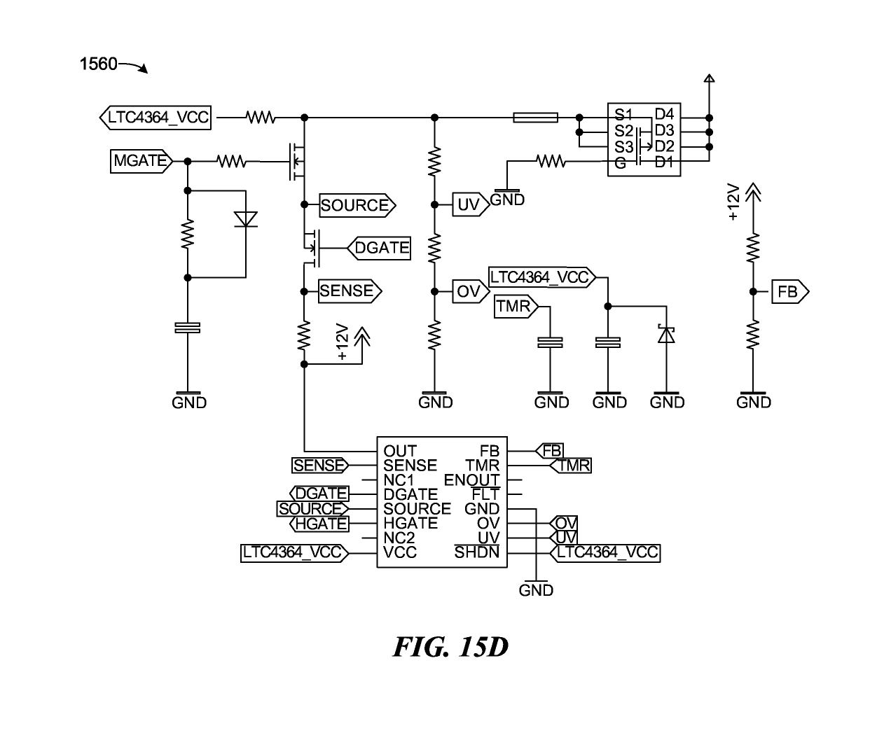

FIG. 15A is an example of a step up converter 1502 of a power supply, such as the power supply 202 of FIG. 2. For example, the step up converter 1502 may take in an inputting DC voltage of 12V and output a DC voltage of 19.5V.

FIG. 15B is an example of a step down converter 1522 of a power supply, such as the power supply 202 of FIG. 2. For example, the step down converter 1522 may take in an inputting DC voltage of 12V and output a DC voltage of 5V.

FIG. 15C is examples of external connectors 1542 of a power supply, such as the power supply 202 of FIG. 2. For example, the external connectors 1542 may also include an inputting 12V connection 1544. The inputting 12V connection 1544 may extend out of the power supply to the chassis wall of the A/V device 200, such as the chassis 212 of FIG. 2, for ease of connections from a portable 12V battery.

The external connectors 1542 may also include one or more step down connections 1546, such as a 5V connection, for one or more components of the A/V device, such as the A/V device 100 or the A/V device 200. The external connectors 1542 may include one or more step up connections 1548, such as a 19.5V connection, for one or more components of the A/V device. Optionally, a general input connector 1550 may be included in the external connectors 1542. The general input connector 1550 may take in an inputting voltage other than a 12V source. The general input connectors 1550 may then be connected to one or more converters in the power supply. FIG. 15D is an example of a protection circuit 1560 of a power supply.

Some portions of the detailed description may be presented in terms of algorithms and symbolic representations of operations on data bits within a computer memory or an integrated circuit (IC) memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state, such as a volatile memory. Thus, for example, non-transitory refers to a device remaining tangible despite this change in state.

The above description and drawings are illustrative and are not to be construed as limiting the invention to the precise forms disclosed. Persons skilled in the relevant art can appreciate that many modifications and variations are possible in light of the above disclosure. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments. For example, an element described in one figure is not necessarily the element of same or similar name in another figure. However, in some embodiments, elements with same or similar names may describe the same common element.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method of constructing a portable audio/visual (A/V) device, the method comprising:
coupling a direct current (DC) power converter to a projector;
coupling the projector to a network-enabled computer board;
attaching the network-enable computer board and the projector inside a portable device chassis with a lens of the projector exposed from the portable device chassis, the portable device chassis adapted to be carried by a single person.

2. The method of claim 1, further comprising:
coupling an infrared camera to the network-enabled computer board; and
attaching the infrared camera inside the portable device chassis with a lens of the infrared camera exposed from the portable device chassis on the same side as the lens of the projector to capture a remote light source movement between a projection screen and the A/V device.

3. The method of claim 1, further comprising:
coupling a web camera to the network-enabled computer board; and
attaching the web camera inside the portable device chassis with a lens of the web camera exposed from the portable device chassis.

4. The method of claim 3, wherein the lens of the web camera is exposed on the same side of the portable device chassis as the lens of the projector to record or share a video of an interactive lesson around a projection screen.

5. The method of claim 3, wherein the lens of the web camera is exposed on a different side of the portable device chassis as the lens of the projector to record or share a video of a classroom setting away from the projection screen.

6. An audio/visual (A/V) device comprising:
a power converter;
a projector coupled to the power converter;
a network-enabled computer coupled to the projector; and
a portable device chassis attached to and containing the network-enabled computer and the projector;
wherein a lens of the projector is exposed from the portable device chassis; and
wherein the portable device chassis is adapted to be carried by a single person.

7. The A/V device of claim 6, further comprising an infrared camera coupled to the network-enabled computer board and attached inside the portable device chassis with a lens of the infrared camera exposed from the portable device chassis.

8. The A/V device of claim 7, wherein a lens of the infrared camera is exposed from the portable device chassis on the same side as the lens of the projector to capture a remote light source movement between a projection screen and the A/V device.

9. The A/V device of claim 6, further comprising a charging station for a portable infrared light source coupled to the power converter.

10. The A/V device of claim 6, wherein the charging station is an induction charging station.

11. The A/V device of claim 6, further comprising a first fan installed on a first vent of the device chassis.

12. The A/V device of claim 11, further comprising a second fan installed on a second vent across from the first vent, wherein the first fan is an intake fan and the second fan is an outtake fan.

13. The A/V device of claim 6, further comprising an audio speaker coupled to the network-enabled computer board and attached to the portable device chassis with the audio speaker partially exposed from the portable device chassis.

14. The A/V device of claim 6, further comprising a carrier handle on the portable device chassis.

15. The A/V device of claim 6, further comprising a leg on the portable device chassis to space a bottom vent of the portable device chassis from a table top.

16. The A/V device of claim 6, further comprising a first audio speaker coupled to the network-enabled computer board and embedded through a first side of the portable device chassis with the first audio speaker partially exposed from the portable device chassis.

17. The A/V device of claim 16, wherein the first audio speaker is tilted upward where a central axis of a center cone of the first audio speaker is pointed at a slant angle above a plane of a bottom side of the portable device chassis.

18. The A/V device of claim 16, wherein a second audio speaker is embedded through a second side of the portable device chassis different from the first side.

19. The A/V device of claim 16, further comprising an audio volume control of the first audio speaker, the audio volume control embedded through the portable device chassis on a side different from where the lens of the projector is exposed.

20. An audio/visual (A/V) device comprising:
a power supply means for providing different direct current voltages to multiple device components;
a projection means for displaying a sequence of images away from the A/V device, the projection means coupled to the power supply means;
a computing means for generating an interactive user interface through controlling the displaying of the sequence of images, the computing means being network-enabled and coupled to the projection means; and
a protection means for holding and containing the computing means and the projection means, wherein the protection means is adapted to be carried by a single person.
